(19) United States
(12) Patent Application Publication
(10) Pub. No.: US 2018/0365201 A1
(43) Pub. Date: Dec. 20, 2018

(54) SYSTEM AND METHOD FOR COMPOUND DATA-DRIVEN CONTRACTS AND DOCUMENTATION

(71) Applicant: Clause, Inc., New York, NY (US)

(72) Inventors: Peter Geoffrey Lerato Hunn, Dallas, TX (US); Daniel Charles Selman, Winchester (GB)

(21) Appl. No.: 16/009,175

(22) Filed: Jun. 14, 2018

Related U.S. Application Data
(60) Provisional application No. 62/519,778, filed on Jun. 14, 2017.
(60) Provisional application No. 62/534,138, filed on Jul. 18, 2017.
(60) Provisional application No. 62/609,341, filed on Dec. 22, 2017.
(60) Provisional application No. 62/639,412, filed on Mar. 6, 2018.
(60) Provisional application No. 62/643,647, filed on Mar. 15, 2018.
(60) Provisional application No. 62/651,165, filed on Apr. 1, 2018.

(51) Int. Cl. G06F 17/22; G06Q 10/08; G06F 17/24

(52) U.S. Cl. CPC G06F 17/2247; G06Q 10/0838; G06F 17/2765; G06F 17/2235; G06F 17/248

(57) ABSTRACT

A system and method that includes a compound contract, comprising of natural language components and a set of programmable components, wherein the compound contract is written in a markup language with the programmable components integrated with the natural language components; and a dynamic layer, wherein the compound contract, through the dynamic layer, is configured to configure programmable components through configuration to: initialize, change, and validate instances of programmable components within the compound contract, interface with at least one external resource, and execute programmable components and execute the compound contract.

### CROSS-REFERENCE TO RELATED APPLICATIONS

This Application claims the benefit of U.S. Provisional Application No. 62/519,778, filed on 14 Jun. 2018, U.S. Provisional Application No. 62/534,138, filed on 18 Jul. 2018, U.S. Provisional Application No. 62/609,341, filed on 22 Dec. 2017 U.S. Provisional Application No. 62/639,412, filed on 6 Mar. 2018, U.S. Provisional Application No. 62/643,647, filed on 15 Mar. 2018, U.S. Provisional Application No. 62/651,165, filed on 1 Apr. 2018, all of which are incorporated in their entireties by this reference.

### TECHNICAL FIELD

This invention relates generally to the field of digital document and transaction management, and more specifically to a new and useful system and method for creating and executing contracts with programmable components.

### BACKGROUND

Commercial documents, such as contracts, are fundamental tools for coordinating economic activity. Typically these take the form of paper-based or computer-based digital representations of ‘paper-based’ documentation. Increasingly, contracts and other commercial documentation are being used in digitally native form: typically comprised of natural language text, often stored in PDF format and, where applicable, augmented with e-signature functionalities. As such, they are inherently static in nature. Although the external environment that relates to the documentation and the parties' conduct pursuant to a contract may change over time, the documentation does not—unless manually amended to account for this. Commercial documentation cannot, for example: store or respond to data inputs and outputs, enable terms and conditions to respond to real-time data, display or otherwise monitor their real-time state (only that at the point of execution or subsequent amendment), respond to the state of the physical world, accommodate dynamic changes to their content over time, store state and version histories, interact with enterprise systems, execute transactions, or automate business processes. Commercial documentation is therefore invariably static in nature, and does not form part of an organization's information technology architecture. This results in a need, often in commercial enterprises, to intensively manage commercial documentation using specialist software (e.g., Contract Lifecycle Management (CLM); Purchase Order (PO) software, etc.).

With the digitization of the physical world through network-connected devices (the “Internet of Things”), Application Programming Interfaces (APIs) and the like, and coupled with the introduction of new transactional technologies including blockchain and distributed ledgers, commerce is increasingly data-driven. Commercial documentation, however, is ill-suited to interface with and use such data. Commercial documents are divorced from commercial processes, information technology systems and applications, workflows, transactions, and the physical world. Therefore, there is a need for a system and method that enables contracts and other commercial documentation to interact with external resources and enable computational functionalities. The disclosed invention provides such a new and useful system and method.

### BRIEF DESCRIPTION OF THE FIGS

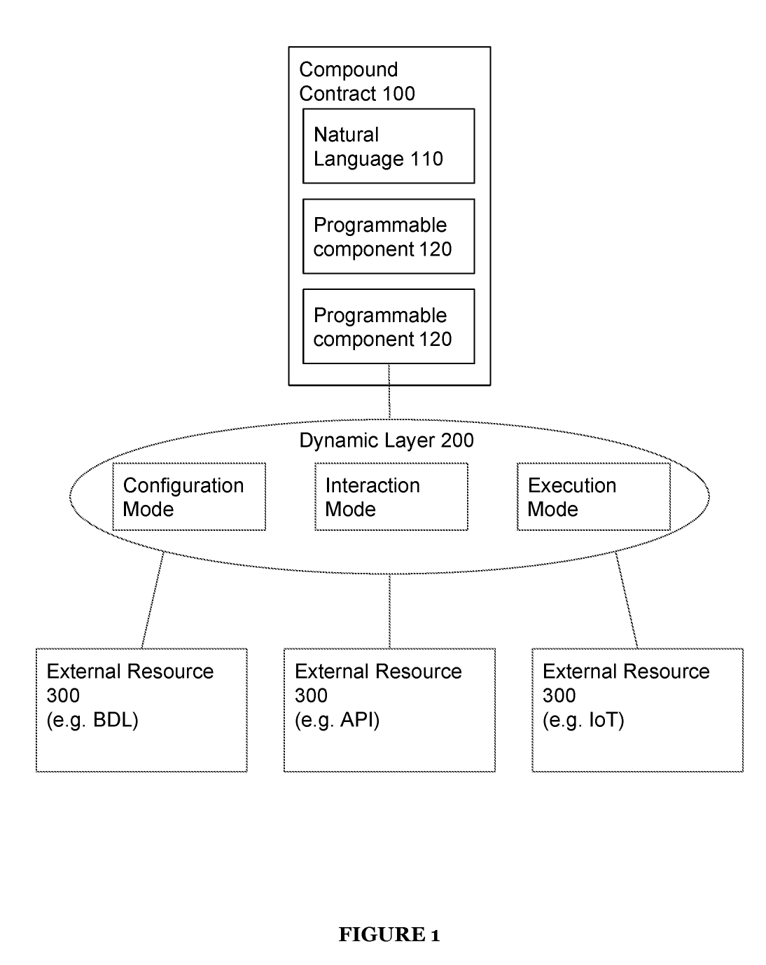

FIG. 1 is a schematic representation of a system of a preferred embodiment;

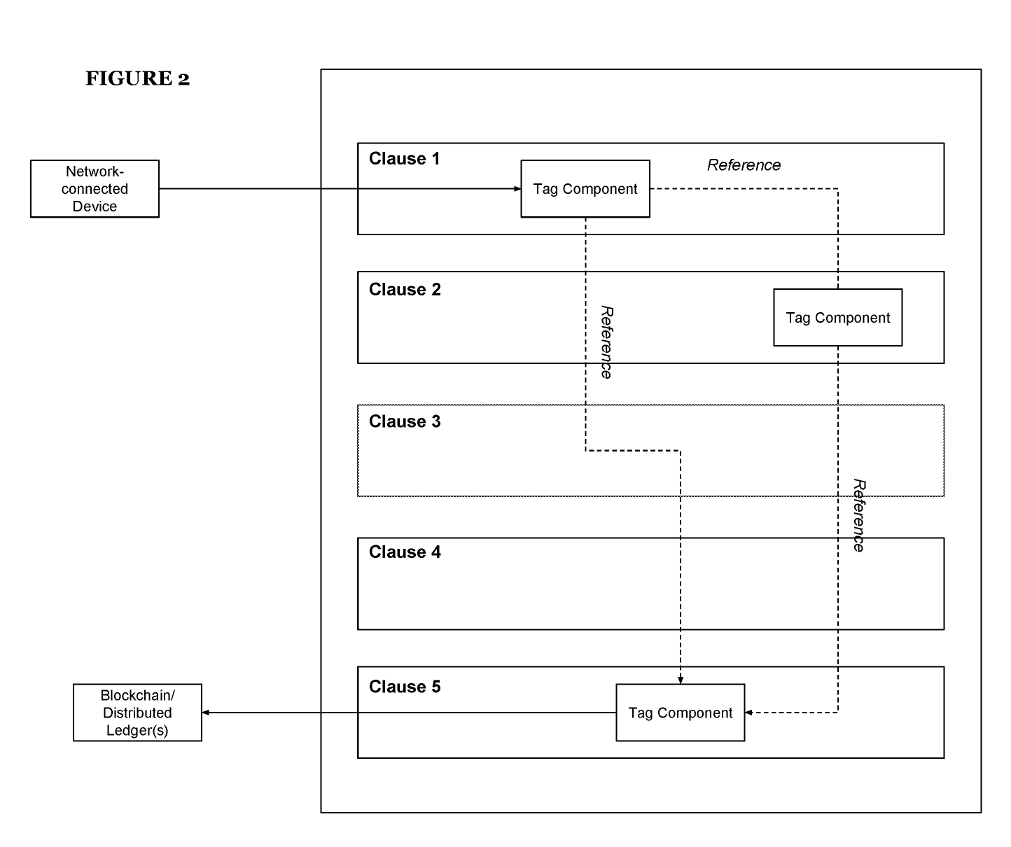

FIG. 2 is a schematic that depicts an exemplary contractual document with tag components and associated resources;

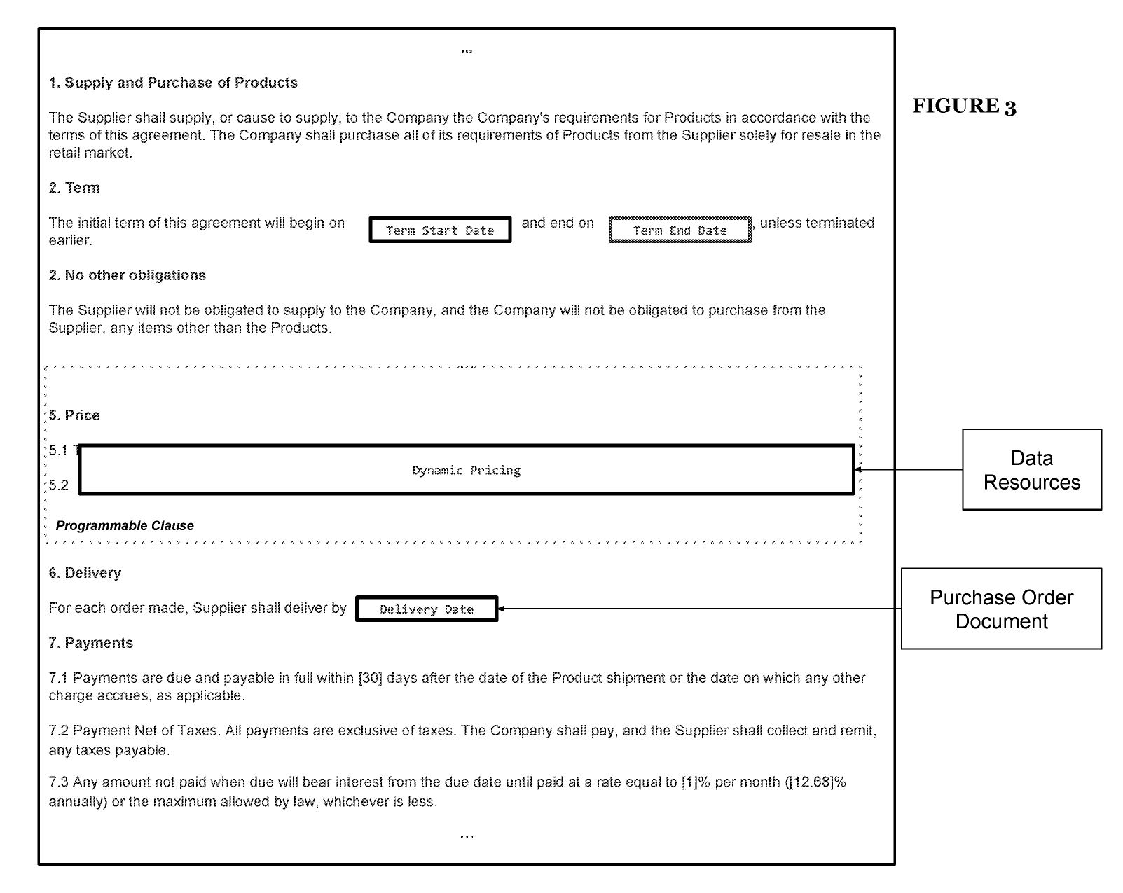

FIG. 3 is an exemplary depiction of a compound document with both tags and programmable clauses and natural language components;

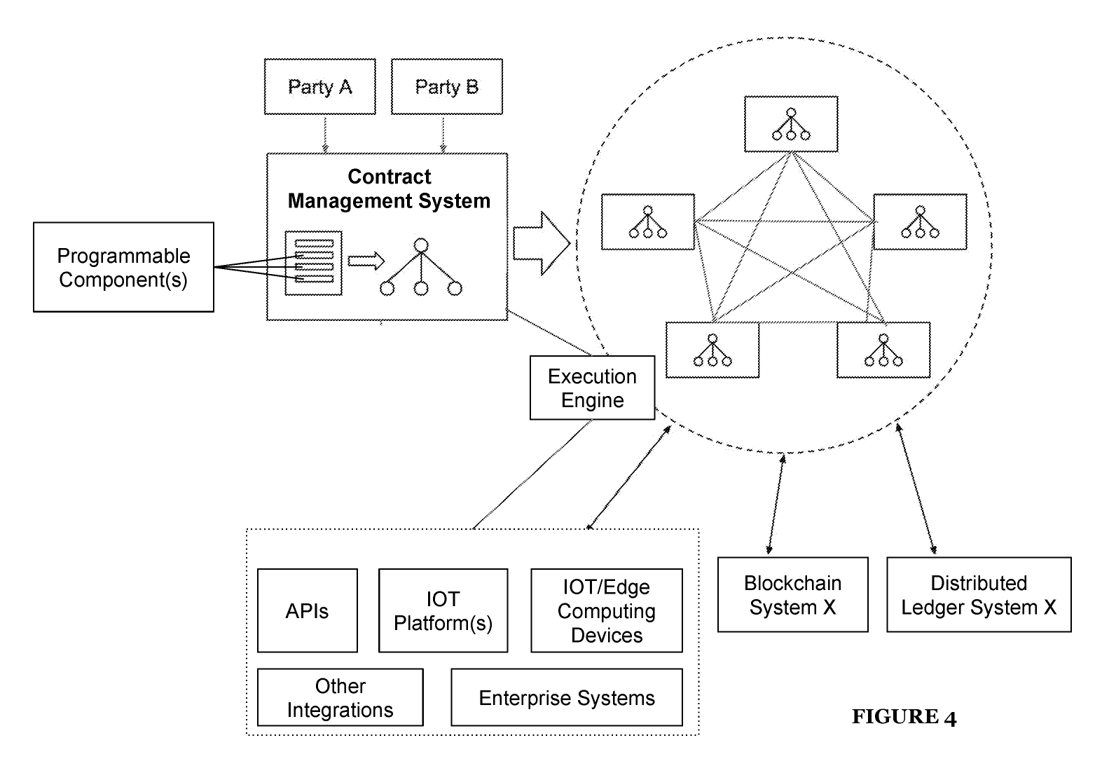

FIG. 4 is a schematic depicting an overview of an exemplary implementation of the system and method;

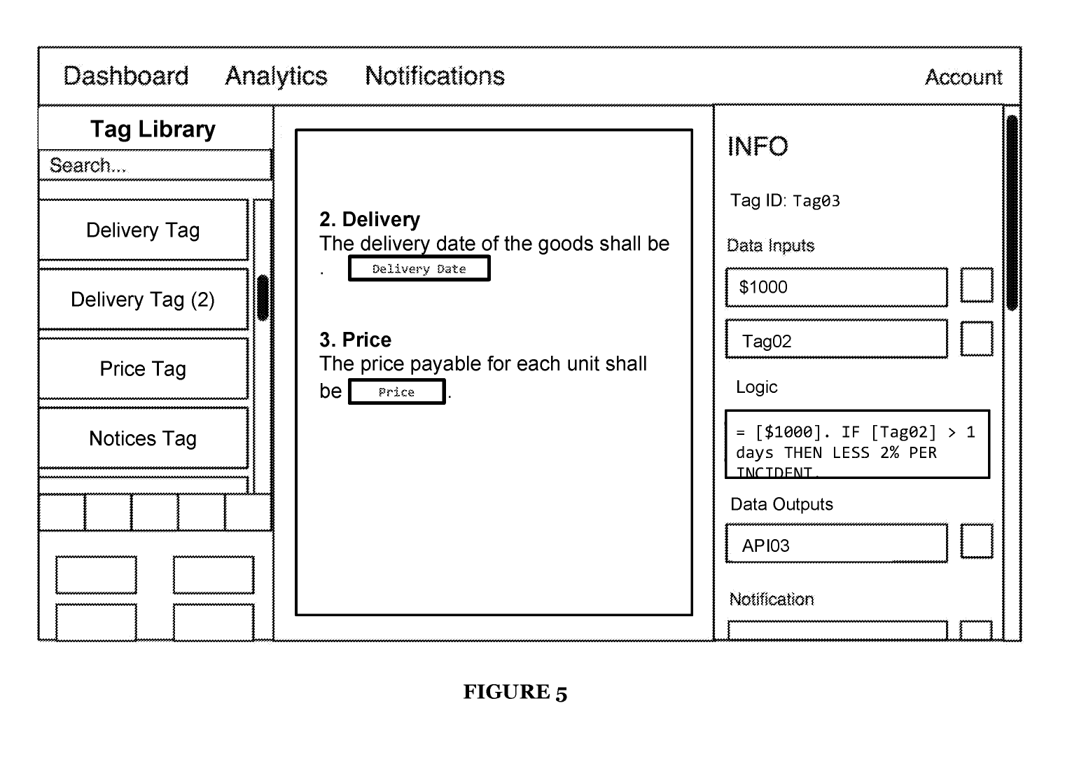

FIG. 5 is an exemplary interface for the configuration of tags in a contractual clause;

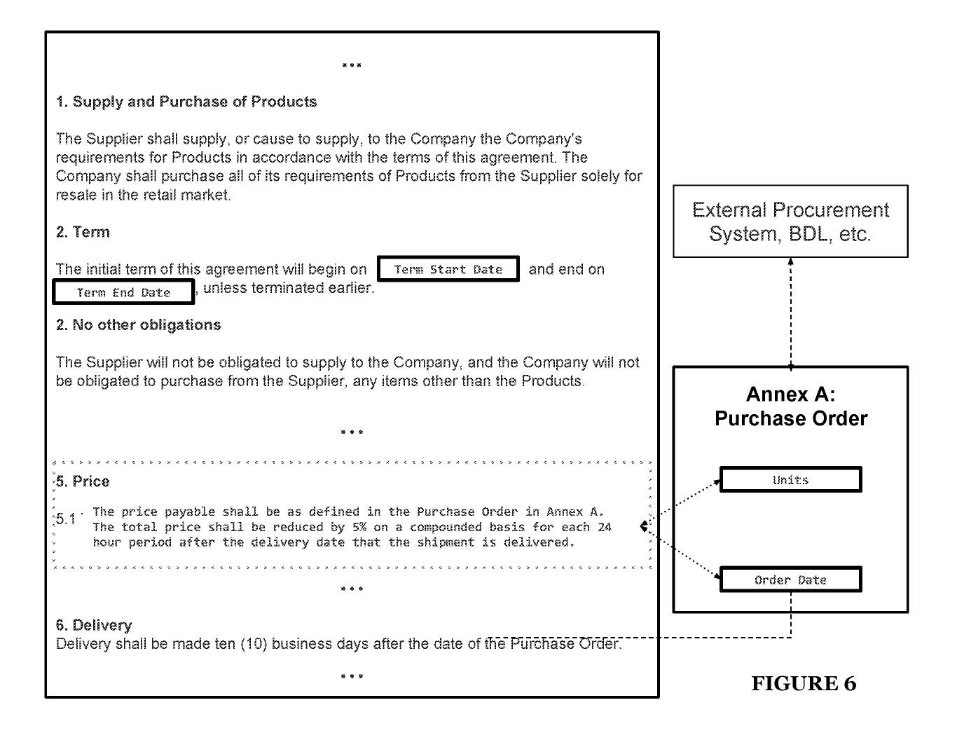

FIG. 6 is an exemplary depiction of a component object displayed within a compound document;

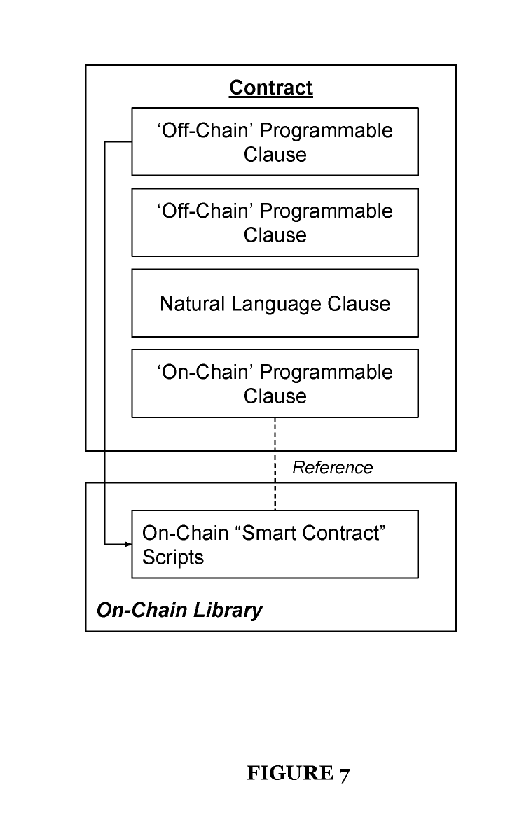

FIG. 7 is a schematic depicting some exemplary means of instantiating programmable clauses using ‘on-chain’ code within a compound document;

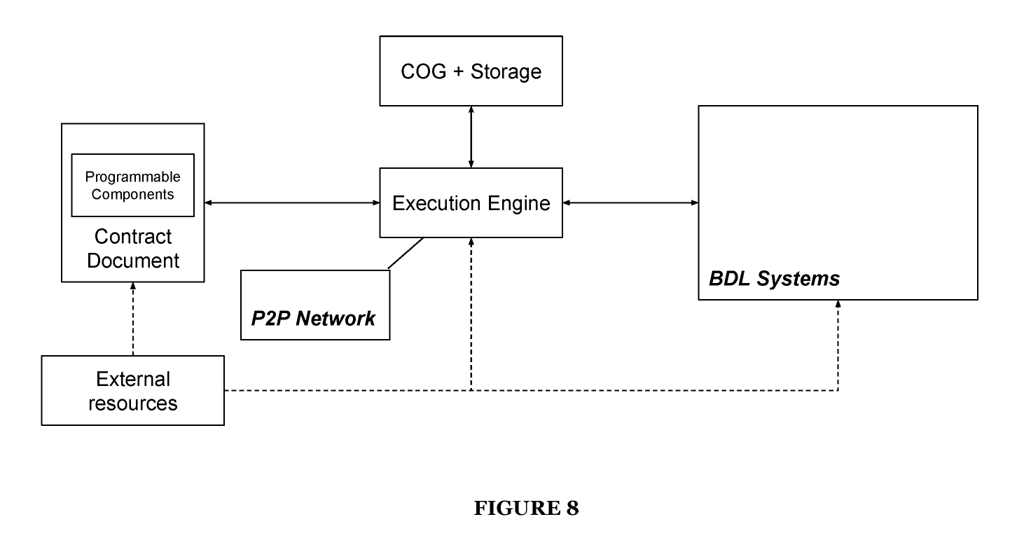

FIG. 8 is a schematic depicting an exemplary architecture of the system and method;

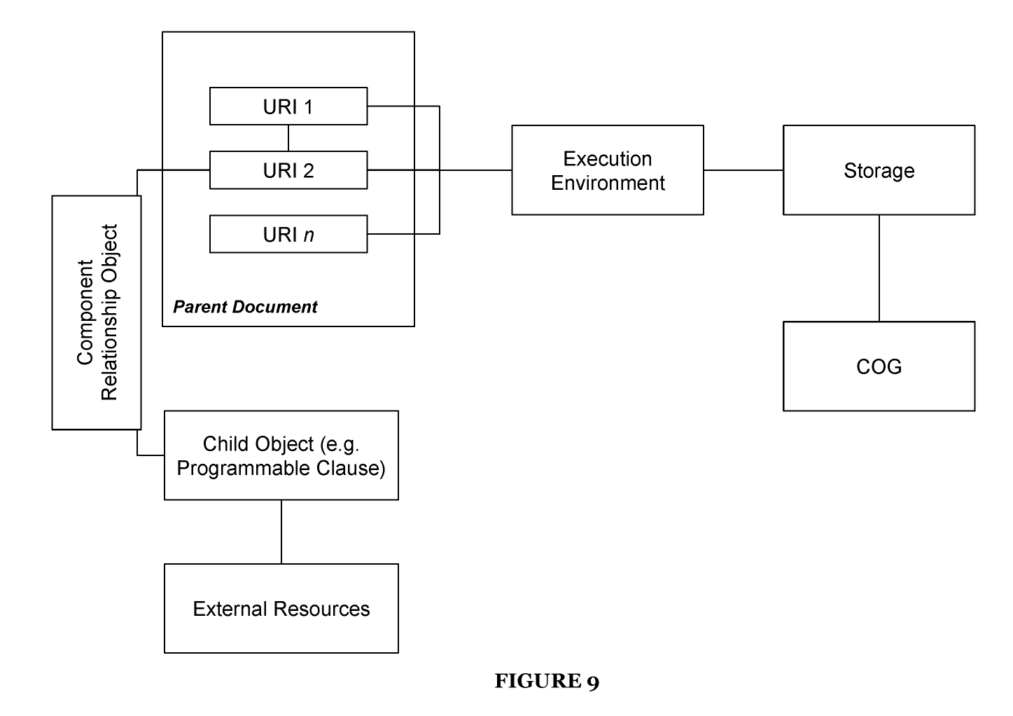

FIG. 9 is a schematic depicting an exemplary structure of a compound contract document;

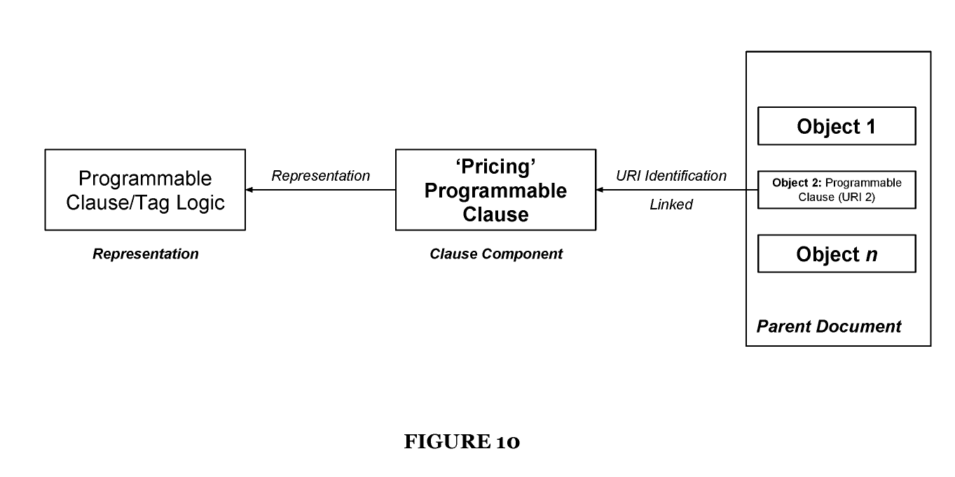

FIG. 10 is a schematic depicting an exemplary composition of a programmable clause or tag within a parent contract document;

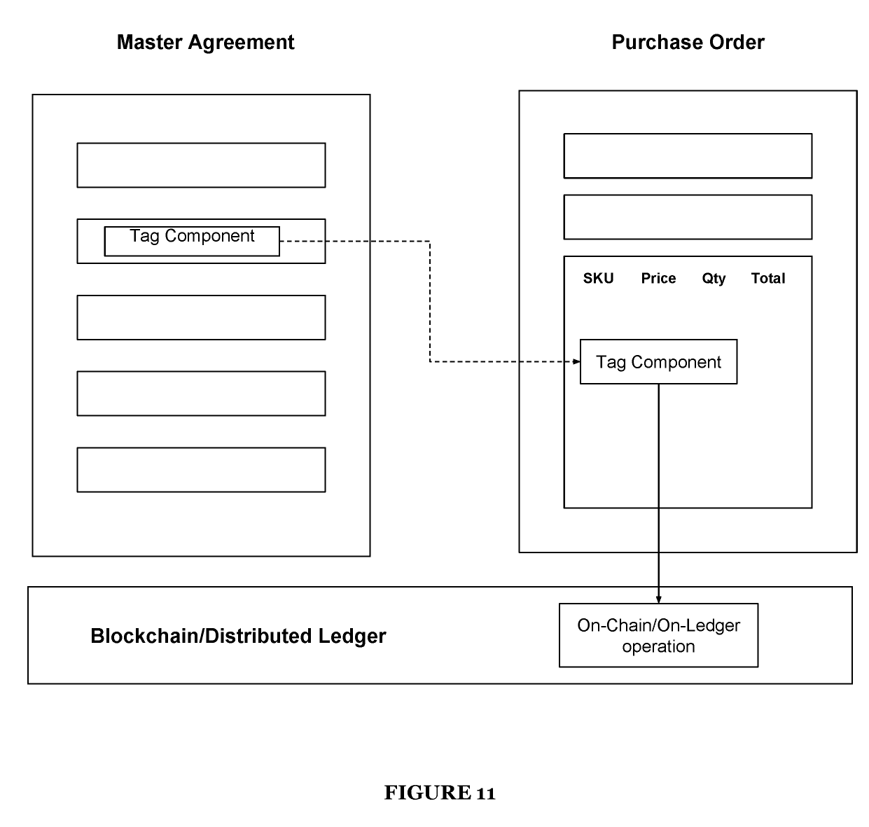

FIG. 11 is a graphical depiction of an exemplary connection between documents through use of a common reference in a tag component;

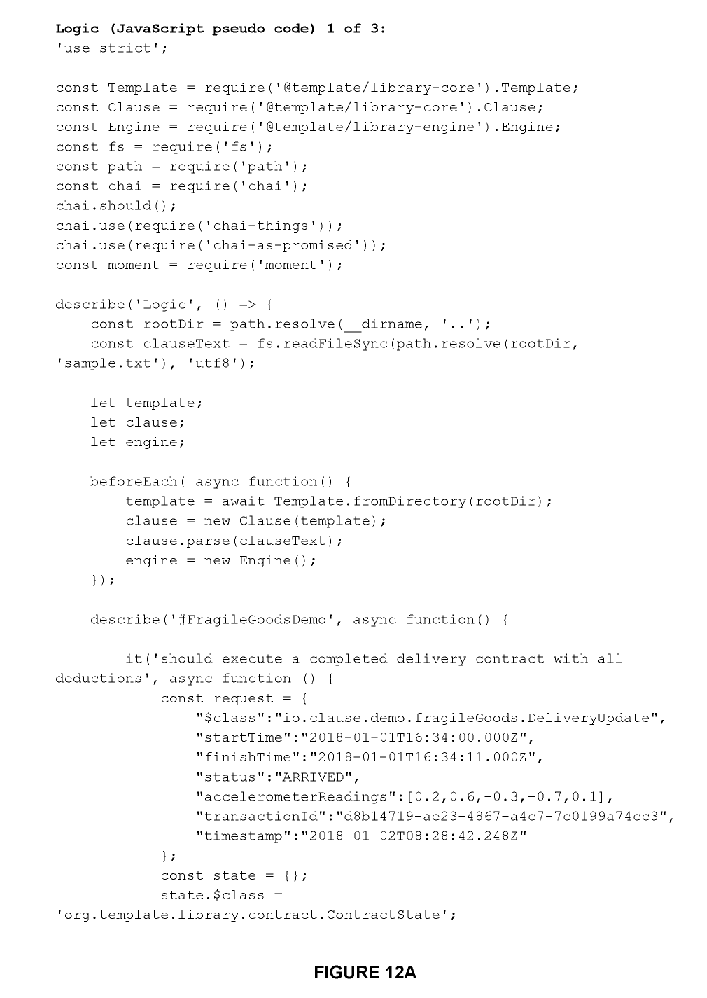

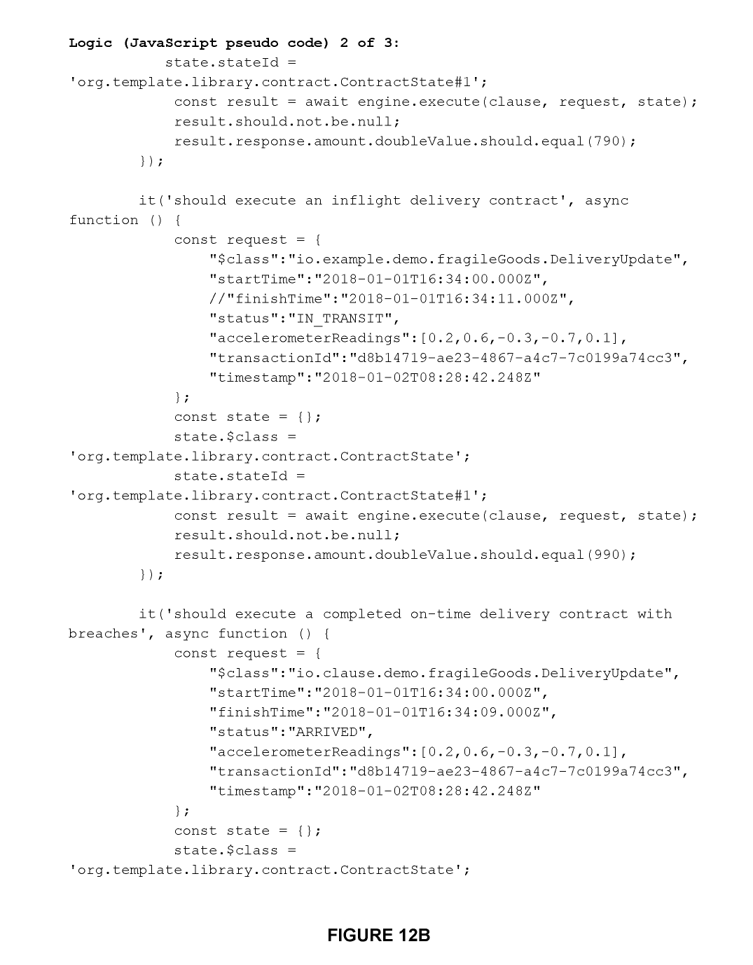

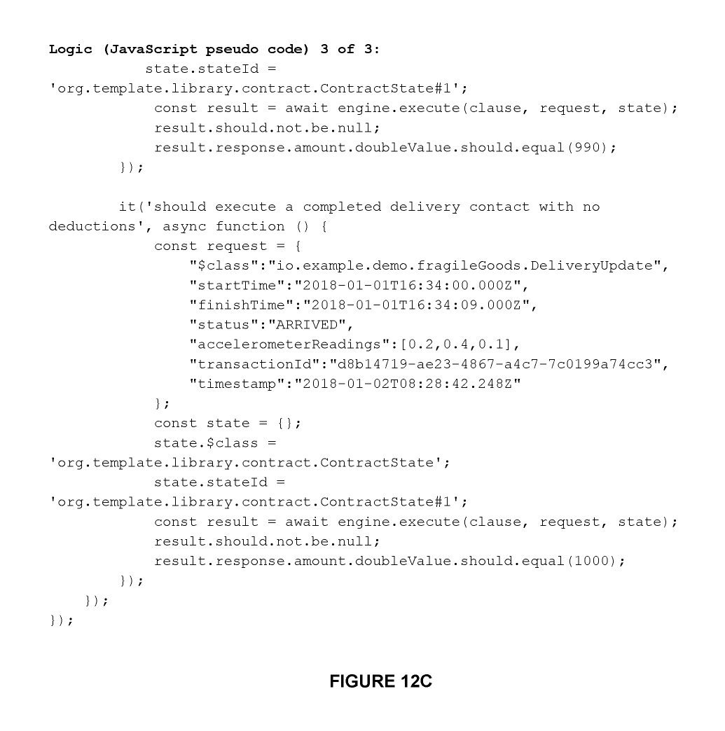

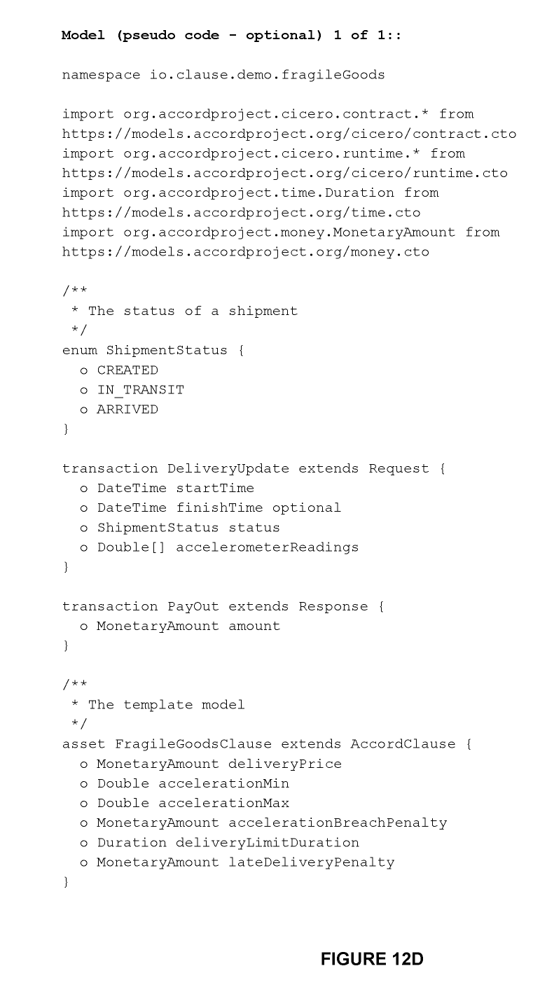

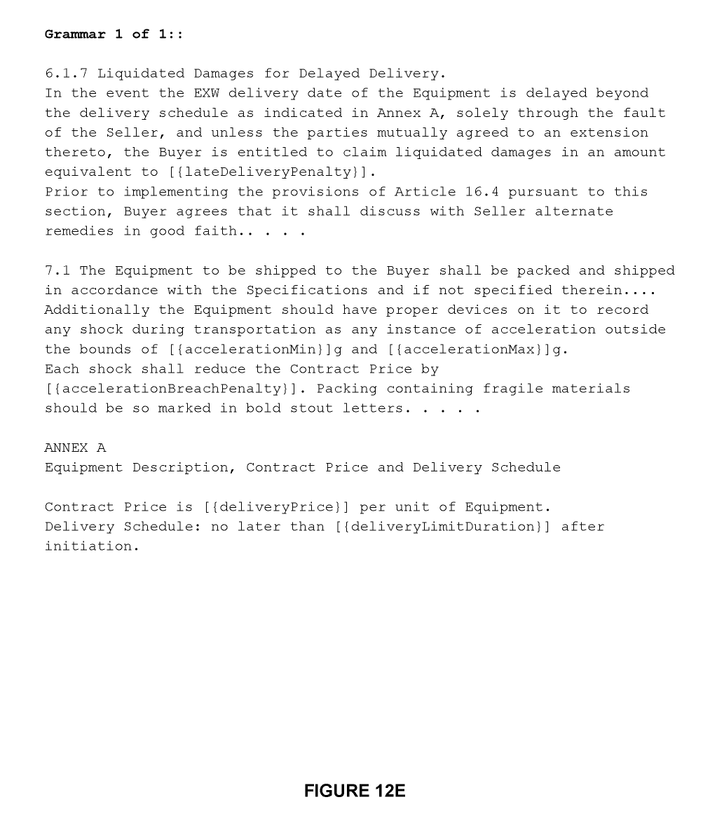

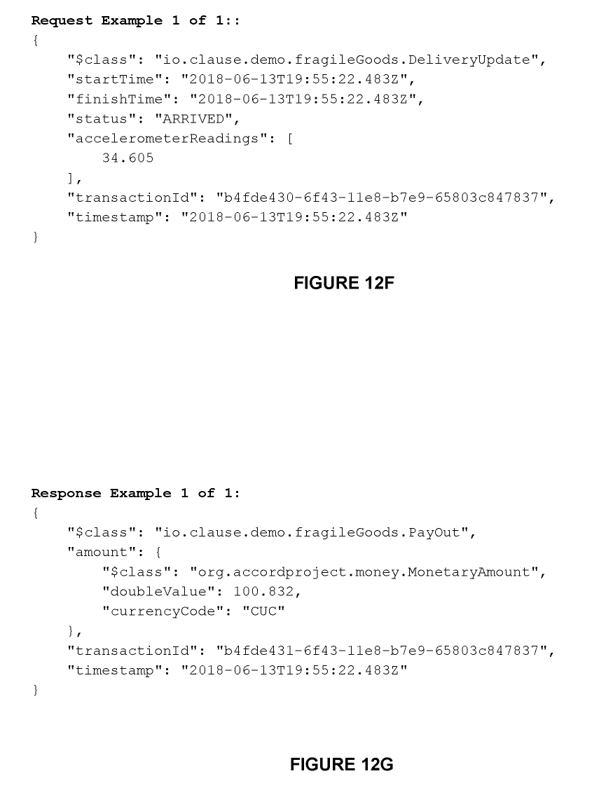

FIGS. 12A-12G serve as a pseudo-code example of an exemplary embodiment of a programmable clause using a high-level language for expressing component logic;

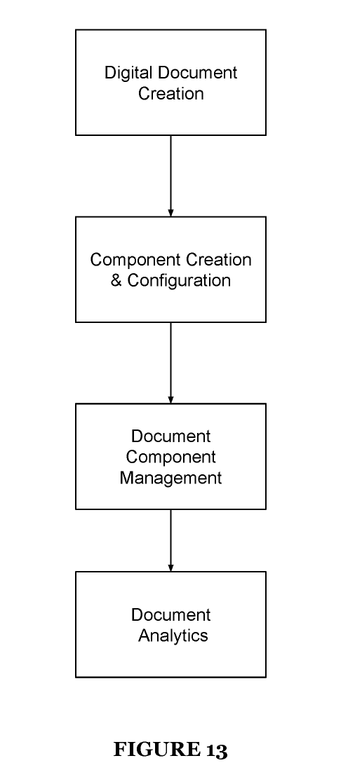

FIG. 13 is a schematic that depicts an exemplary life cycle of a document with tag components;

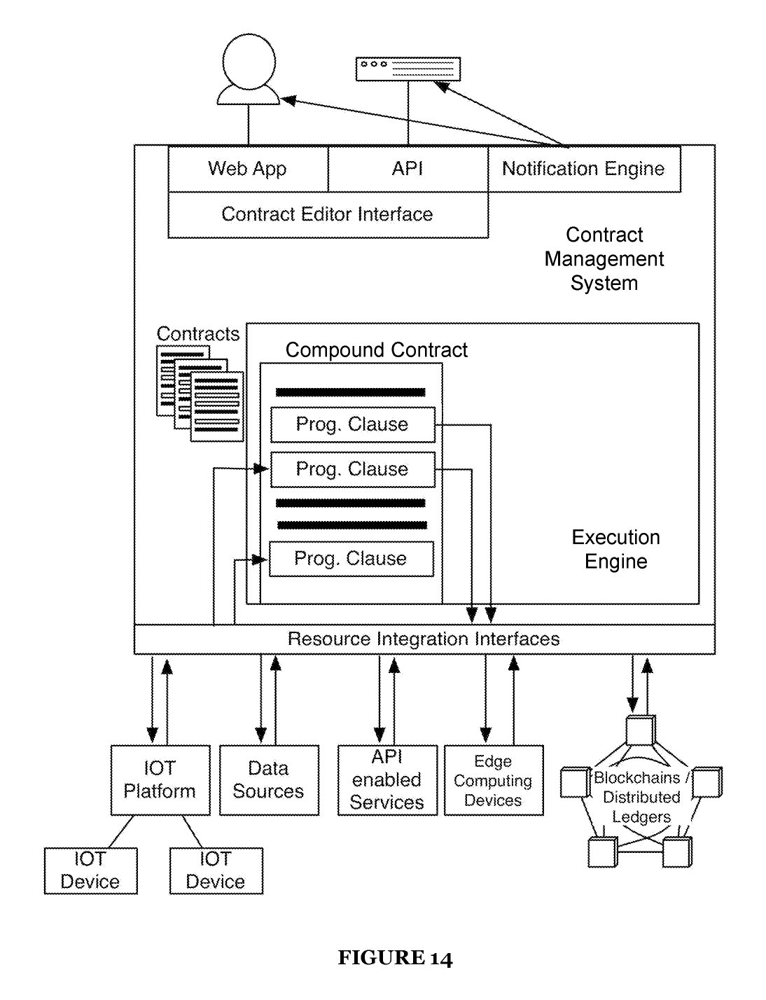

FIG. 14 is a schematic depicting an implementation of the system and method depicting programmable clauses in a contract compound document;

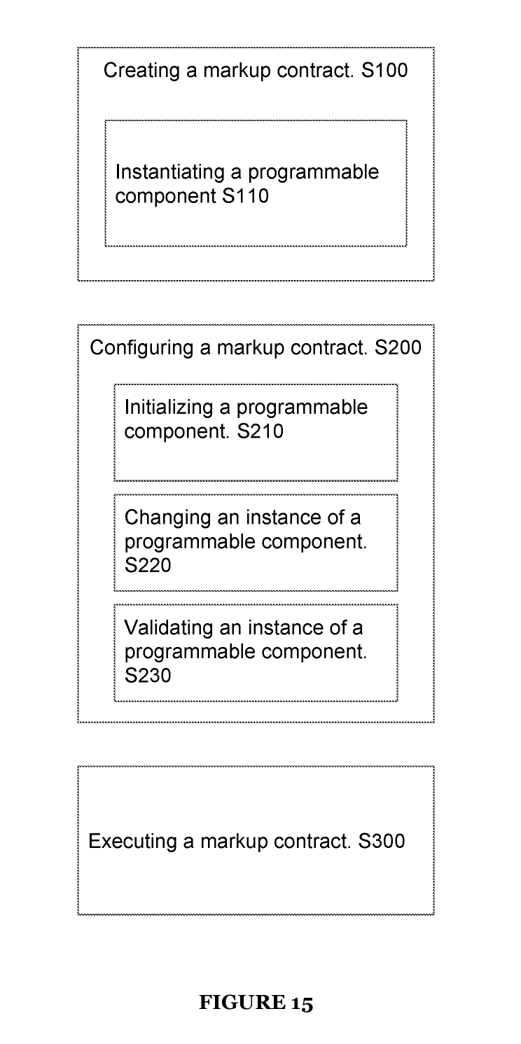

FIG. 15 is a flowchart representation of a method of preferred embodiment;

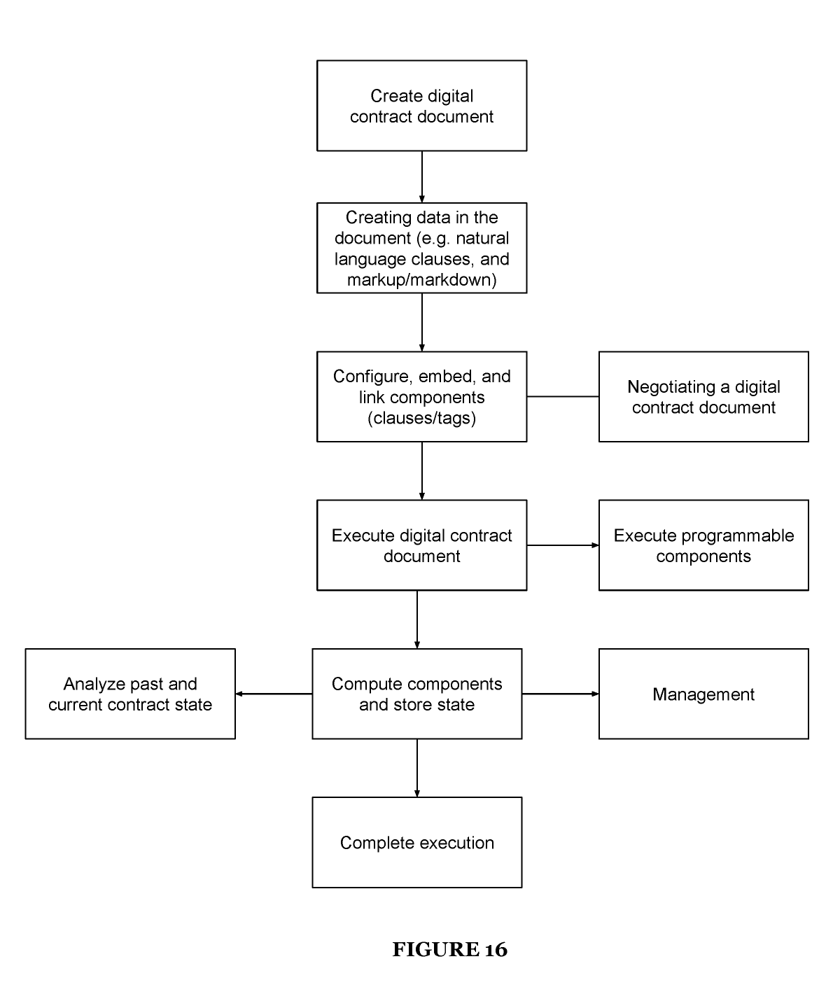

FIG. 16 is a flow diagram demonstrating an exemplary means of using the system and method;

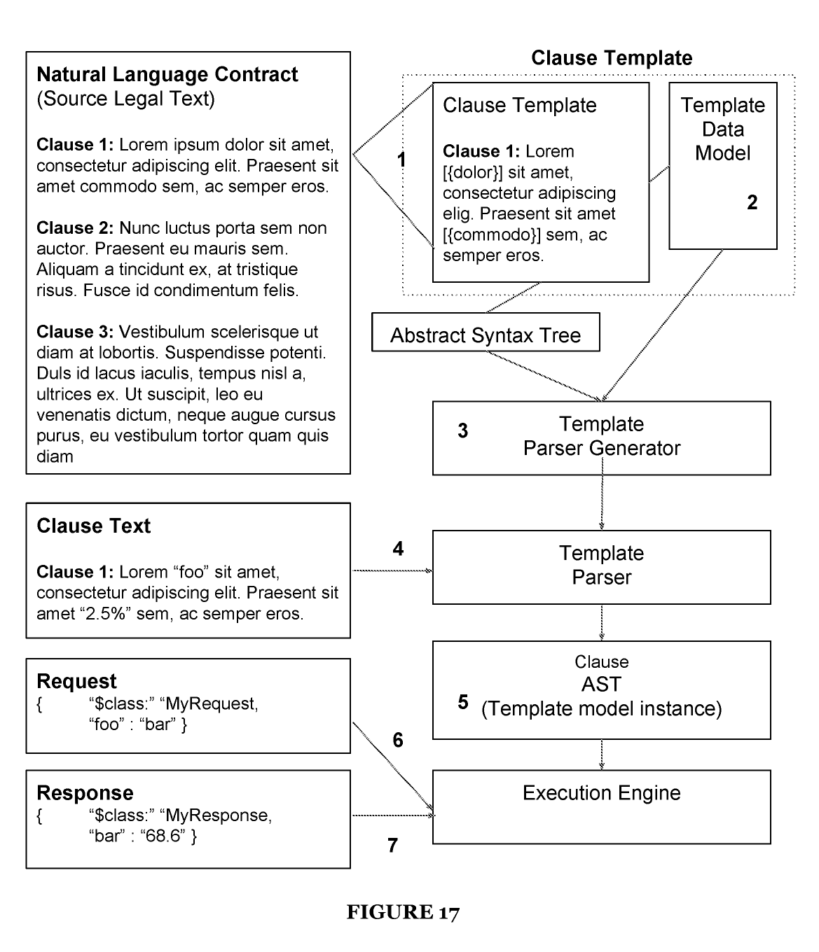

FIG. 17 is a schematic depicting an exemplary structure of a templating system;

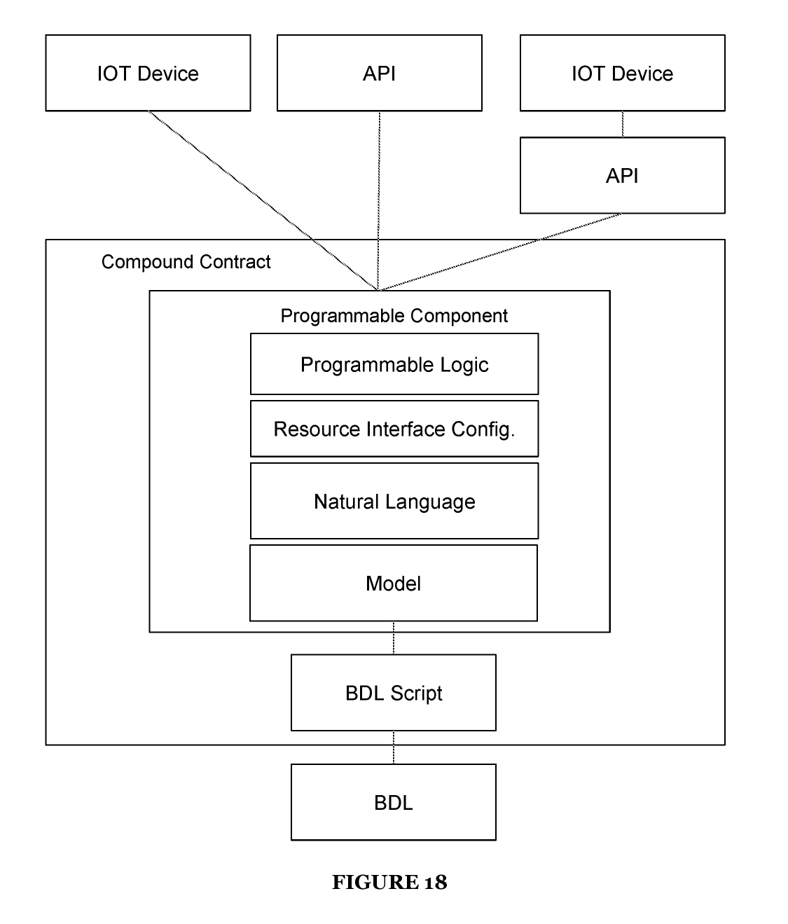

FIG. 18 is a schematic depicting an exemplary interaction between a programmable component in a document and a blockchain/distributed ledger implementation; and

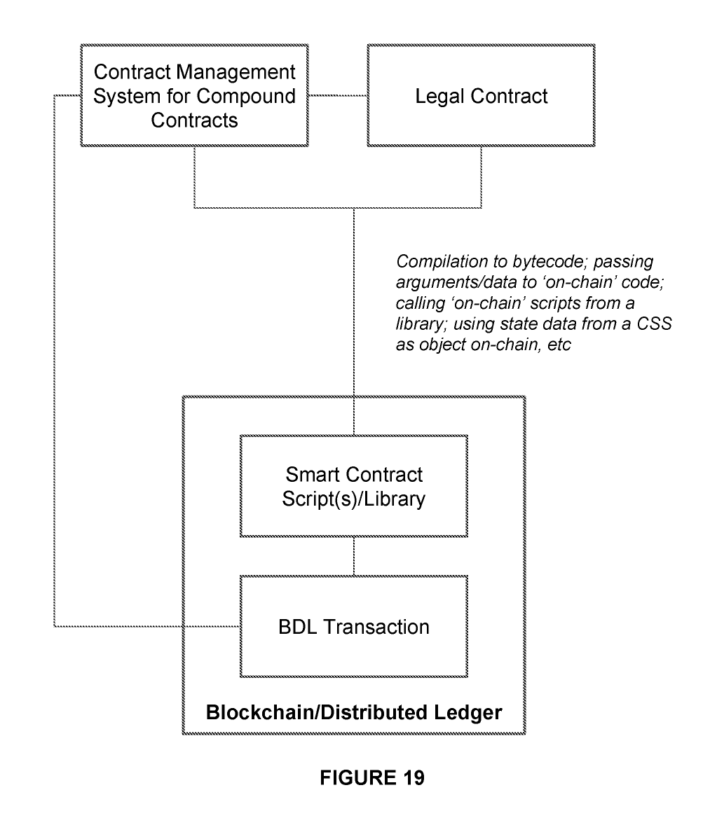

FIG. 19 is a schematic depicting an exemplary interaction between a compound contract and a BDL.

### DESCRIPTION OF THE EMBODIMENTS

The following description of the embodiments of the invention is not intended to limit the invention to these embodiments but rather to enable a person skilled in the art to make and use this invention.

### 1. Overview

A system and methods for the creation, execution, and management of compound contract documents using embedded and linked objects representing programmable components in contracts is included herein. These compound contract documents can preferably enable the application of such embedded and linked objects within a markup contract. The system and method may also be used with other forms of documents. The system and method includes creating a digital document, typically using a word processor/collaborative word processing system, embedding, and/or linking programmable contract clauses and other components that enable, amongst other functionalities: (a) programmable logic representing contractual clauses and other elements to be instantiated within the document; and (b) data from, and connections to, external resources to be instantiated. The system and method thus include approaches for a contract (or set of contracts) to be augmented with programmable components. Herein, programmable components will typically refer to, but not be limited to, programmable clauses and tags. Programmable clauses and tags are added to a document to utilize logic based executable components connected to external sources within the body of the document. The system and method thereby may enable a link between external resources and a contract or other document to be created. Embedded programmable component functionalities may have a multiplicity of applications, including (but not limited to) contracts and commercial documentation (such as purchase orders, invoices, packing lists, leases, letters of credit, etc.).

The system and method can offer a number of potential benefits. One such potential benefit is that the system and method may enable users to add functionality to new and existing documents; principally in the form of data-driven logic-based components that may drive non-natural language based functionalities both within the document, and with respect to external resources (e.g. APIs, blockchains/distributed ledgers, etc.). The system and method may enable a document to include programmable expressions that enable the automation of a variety of operations—both internal to the document and external to it. A logic-based expression may enable a document to interface (both input and output) with external data and resources (e.g. APIs, applications and systems, blockchains/distributed ledgers, databases, edge computing and network-connected devices, event processing systems, analytics systems, rules systems, and many more). Data may then be used from these resources for logic computation. For example, a logic-based expression may use data from an external data source to calculate a value (e.g. price) within a document such as a contract, invoice, purchase order, letter of credit, or other document. As well as data being inputs from resources being used for tag component computation, data may also be output from documentation tag components to external resources (including other tag components in the same or other documents). For example, a tag may output data to an invoicing system via API to reflect updated prices based upon the state of a contract. The system and method therefore has the benefit of enabling commercial documents to actually perform physical world and other events (e.g. transactions, administrative updates to systems, etc.), rather than simply acting as documentary evidence of acts that are to be performed by the parties to a contract or in other related workflows.

A further benefit of the system and method is that contracts—through the use of programmable clauses and tags—may utilize distributed ledger systems or related systems, including those that offer decentralized computation or “smart contract” functionalities. A distributed ledger system may take any suitable form. In one form, a distributed ledger system may take the form of a blockchain system. In another form, a distributed ledger may take the form of a Directed Acyclic Graph (DAG) based architecture. Current approaches require cumbersome techniques for matching or mapping natural language of a contract document with “smart contract” execution functionalities. In addition, BDL “smart contract” systems which have technical limitations, are inherently inflexible (often resulting from the consensus mechanisms used), and non-contractual in nature. For example, today, “smart contract” systems typically suffer from, inter alia, scalability, interoperability, cost, performance, and/or privacy issues.

Herein, BDL is used herein to refer to distributed ledger systems and/or more specific consensus-based blockchain solutions, wherein any suitable variation or combination of such systems may be used. References to BDL systems, platforms, integrations, transactions and the like could be distributed ledger variations or blockchain variations. Cryptographic databases, and/or other suitable systems with BDL-like features may be additionally or alternatively be used in a similar manner as the BDL components.

A related potential benefit may be that the system and method enables these functionalities to be added in the process of creating natural language contracts in a manner that is familiar to users.

A further potential benefit is that the system and method may facilitate the creation and adoption of so-called “smart contracts”. “Smart contracts” are typically implemented as distributed executable code that runs on a BDL system. The code may execute business operations or workflows between entities. However, “smart contracts” are not necessarily inherently contractual and are not themselves linked to documentation that may govern or pertain to such transactions. In this sense, “smart contracts” are likely divorced from legally operative or governing contracts and other commercial documentation. Clause and tag components may be utilized within digital contracts (and other documentation) that interface with ‘on-chain’/‘on-ledger’ code to execute transactions on, or otherwise perform or delegate computation to one or more BDL systems. For example, a component within a contract may execute a transaction transferring a token or digital asset on a BDL when a good is delivered (per data provided via a delivery/logistics API). Multiple transactions may be effected by a component (e.g., upon delivery of a good with respect to a ‘delivery’ component within a clause in a contract, a payment may be effected by a ‘payment’ component within a payments clause that specifies the terms of payment.

With this approach, the system and method may enable a hybrid interface between: (a) traditional natural language contracts and other documents; and (b) “smart contracts” and associated protocols. The potential benefits being that contracts are capable of merging machine-readable elements, in the sense that transactions may be executed on BDLs, and other similar systems based upon certain conditions occurring, with human-readable elements that may better readily conform to typical legal and commercial practices and approaches. Effectively, this may enable “smart contract” based operations to be performed within a traditional contractual structure and contracting paradigm.

Furthermore, the system and method may enable a hybrid “smart contract” paradigm in which the computable aspects of a contract operate both ‘off-chain’ and ‘off-chain’ (see FIG. 18). For example, a contract of the system and method may embed or otherwise utilize logic (e.g., via ‘on-chain’ scripts) that performs ‘on-chain’ operations as well as ‘off-chain’ operations. This may provide the benefit of flexibility of computing the logic of a contract, in whole or in part, without the use of a BDL, but perform transactions on-chain using BDL scripts where appropriate. For example, a programmable component within a contract document may calculate the current price payable under a pricing provision (e.g., based upon delivery data from an external source) and effect an operation using the calculated output ‘on-chain’. The same may apply to provisions of a contract document that are not ‘dynamic’ in the same sense, but are desirable to be kept ‘off-chain’ but still associate with an ‘on-chain’ transaction/operation (e.g., personally identifiable or commercially sensitive information such as purchasers names, asset details, etc.). Such a structure may significantly mitigate some of the aforementioned technical issues with “smart contract” enabled BDL systems whilst maintaining the technical benefits of BDL-based systems (e.g., distributed computation and transaction execution) where desirable.

The system and method may, therefore, reduce friction in the use of BDL protocols as the tag (or other component) may be set to execute operations on a distributed ledger within a document. This includes interaction not just with BDLs that provide generalized computation, but also with ‘use case specific’ BDLs (e.g. trade finance, supply chain, intellectual property/digital rights management, etc.) thereby enabling interaction therewith to be set within the context of a legal or other document. As such, a legal contracting ‘layer’ may be added to these systems.

An associated potential benefit of the system and method is that it may reduce friction and improve adoption of digital transaction management solutions and computable contracts. Digital transaction management solutions typically suffer from a lack of ability to consume document data within their systems—particularly dynamically as the documents are static and not connected to external systems. Computable, logic-based, and data-driven functionalities may be embedded into documents using a user-friendly interface and process. This may be particularly beneficial to abstract away complexity that would exist without such a system and method.

Another potential benefit is that the system and method may facilitate contracts that are at least partially ‘self-managing’. Contracts may be ‘self-managing’ in the sense that outputs are generated by tags or clauses that perform actions on external resources (including other programmable components) based upon the state of the contract. For example, an operation may be performed on an external system via an API when a price change in a contract occurs (e.g., an event occurs that reduces price, and the new state of the price in the contract is output to an accounting system). In another example, the output may be to another tag or clause to automate more complex logic across a contract, such as where a delivery but in a manner that is late—as per the logic of the delivery tag/clause. The state of the ‘delivery’ tag/clause may then be used as an input to a ‘price’ tag/clause that calculates the price based upon delivery status (e.g., where the logic may be X % reduction per Y days late). This may significantly benefit CLM processes that often rely on an intermediate software layer to assist users in managing contracts, obligations, workflows, business operations and the like.

Another potential benefit is that the system and method may facilitate the use of more useful templates. Use of programmable clauses and tags may enable a user to create a template with components that replace traditional fields within a contract or other document. For example, input parameters (e.g., price values, dates, addresses, etc.) can be used within a contract to specify dynamic inputs and logic on those inputs. This may enable users to automate actions from contracts without significantly detracting from existing contract creation workflows. Use of programmable components within a markup document may enable any natural language within the document to be changed, whilst enabling the logic of the components to be determined. A user may specify the natural language to meet their drafting requirements and specify the logic of the component to determine the basis of a computation/operation.

A further potential benefit is that the system and method may create a feedback loop between the document and other systems. The ability for a document to input, process, and output data means that such systems may themselves utilize that data—often in real-time or near real-time—and external systems may receive data that is processed in accordance with the content of a contract (e.g., its terms and conditions) or other document; meaning that synchronization between the systems is potentially vastly improved. A contract or other document may consequently be integrated within existing workflows and enterprise processes. The input/output functionality of a programmable component enables it to interact with external resources and other programmable components. As such, the state of the contract may be utilized—either in real-time, near real-time, or otherwise—by external systems. For example, an accounting system or risk management system may be able to utilize price changes, liabilities etc. in real-time.

### 2. System

As shown in FIG. 1, a system for digital contract management of a preferred embodiment can include a compound contract 100 comprised of natural language components 110 and a set of programmable components 120, wherein the compound contract is written in a markup language or otherwise configured with the programmable components integrated within the natural language components; and a dynamic layer 200 that enables the compound contract to have modes of operation comprising of: a configuration mode, that enables initialization, change, and validation of a set of programmable components within the compound contract; an interaction mode, that enables the compound contract to interact with at least one external resource 300, and an execution mode that enables execution of the compound contract and/or execution of subcomponents of the compound contracts.

The compound contract of a preferred embodiment functions essentially as a contract forming an agreement between multiple entities, but with significant added functionality due to programmable components of the contract. These additional functions may include providing ‘dynamic’ real-time or near real-time state of the contract (e.g., providing the current state of a price under a pricing clause), changing or updating terms and conditions of the contract, terminating/cancelling the contract, executing the contract, enforcing the terms of the contract, performing administrative actions on external resources (including synchronizing external systems to the state of a contract), and/or any additional functionality that may be of use to a contract. Additionally, the compound contract may be configured to interface with external sources. The compound contract is preferably a dynamic markup document. More specifically, the compound contract includes natural language elements and programmable components, wherein executable programmable components are embedded within the natural language text of the document.

Programmable components, (e.g., programmable clauses and tags) may be added into documents alongside natural language using a compound document framework (see FIG. 2). FIG. 3 shows one example of programmable components embedded within natural language components of the compound contract. Programmable components may be instantiated into a parent document. The parent document may itself be a compound document (e.g. a digital document may itself be a compound of other documents and data). Instantiated programmable clauses and tags may take the form of a binary executable, container, externally hosted code executed in a runtime environment, or other appropriate form. Multiple forms may be used in a given document. Alternatively, the compound contract may include only natural language components, or only programmable components, and/or other suitable alternatives or combination of alternatives. Compound contracts are preferably implemented as software components that are executed on a networked system. This may include a cloud-based platform, a distributed or decentralized network (such as a peer-to-peer overlay network), a blockchain or other distributed ledger, or other appropriate system architecture. The present invention may be implemented as standalone software components or integrated into a larger system. FIG. 4 provides an exemplary overview of one potential wider implementation of the system. As one potential framework, changes in the compound contract and its state may occur through actions layers comprised of: a dynamic layer that configures for internal configuration of the compound contract, an execution layer that configures for execution of the compound contract, and an interface layer that configures for interaction of the compound contract with external sources. The framework of a dynamical layer, an execution layer, and an interface layer is one preferred implementation, but any suitable framework or implementation of the system of configured component may alternatively be used.

The dynamic layer of one preferred implementation may function to give the compound contract a configuration mode. That is, the compound contract, through the dynamic layer, may configure some subset of programmable components. Configuration of programmable components may be comprised of configuration to initialize programmable components, change programmable components, and validate instances of programmable components. Through the dynamic layer, the compound contract may additionally configure natural language. The dynamic layer may preferably create an inclusive operating mode. That is, the dynamic layer operating mode may operate simultaneously, in synchrony, in some complementary fashion, independently, and/or any other variation with other operating layers of the system. In some variations the dynamic layer may function simultaneously, synchronously, and/or in some complementary fashion with external sources. Preferably the configuration mode may occur prior to, during, and post execution of the compound contract.

The interaction layer of one preferred implementation may function to give the compound contract an interaction mode. That is, the compound contract, through the interaction layer, may interface with at least one external source, such as an API, network-connected device, application, system, database, BDL, or any other suitable entity. Interaction may be both on an input and output basis. The interaction layer may create an inclusive operating mode. That is, the interaction layer operating mode may operate simultaneously, in synchrony, in some complementary fashion, independently, and/or any other variation with other operating layers of the system. In some variations the interaction layer may function simultaneously, synchronously, and/or in some complementary fashion with external sources.

The execution layer of one preferred implementation may function to give the compound contract an execution mode. That is, the compound contract, through the execution layer, may execute the actions, logic, and/or terms of the contract or other appropriate processes (e.g., workflows, business process). The execution layer may preferably create an inclusive operating mode. That is, the execution layer operating mode may operate simultaneously, in synchrony, in some complementary fashion, independently, and/or any other variation with other operating layers of the system. In some variations the execution layer may function simultaneously, synchronously, and/or in some complementary fashion with external sources. In some preferred examples, the contract executes only once (e.g., a time/moment that all contract parties have agreed upon). For the preferred single execution contract, contract effects prior to execution may be referred to as pre-formation and contract effects after execution may be referred to as post-formation. Alternatively, the compound contract may be executed multiple times or never. The execution of the contract may be instantaneous, but may alternatively happen over some known, or unknown time period. Programmable components that effect the execution may be added, removed, or changed during non-instantaneous execution. Changes in effecting programmable components, may change the results of the execution of the contract, change the duration of the execution, and/or may cause the compound contract to fail in execution (mid-execution).

Natural language content is preferably a component of the compound contract. The natural language component of a compound contract functions as the text of the contract. This is the text of a, potentially binding contract, including all the details that may be considered necessary for the legitimacy of the contract. Necessary details of the natural language component may vary from region to region, and may also differ due to the topic of the contract. Natural language may be in English for example, or any other written language, but may alternatively be in a coded language, encrypted form, machine language, or any other alternative form of “natural language” that can convey information. In non-contract based applications of the system and method (e.g., invoices, letters of credit, packing lists, bills of lading, and other documents), text may not be contractual prose, but instead to provide the non-programmable elements of the document.

The programmable component of a preferred embodiment is an element of the compound contract. A programmable component functions as a dynamic programmable logic-based executable component embedded or linked within a contract. A programmable component may preferably be a programmable clause or a tag but may alternatively be any other suitable programmable component. Programmable clauses and tags are added to a document to utilize logic-based executable components within the body of a document, which may be based upon interaction with external resources. Addition of a programmable logic may preferably be in the form of markup text, wherein the programmable components are interspersed within natural language. A markup language of a preferred embodiment is preferably capable of expressing any arbitrary logic. The programmable logic of a component may itself be expressed in a markup language, using a markup language in combination with other forms/expressions of programmable logic (e.g., high-level programming languages, low-level programming languages, bytecode, machine code, markdown languages, or any other form of expressing executable logic), or programmable logic without a markup element (e.g., using the aforementioned forms alone). In one particular implementation, the logic of a programmable component may wholly or partially take the form of a executable code that is hosted externally to the document (e.g., on-chain BDL scripts, off-chain logic, etc.). The markup text could use a programming language, domain-specific language or any suitable programming, logical, or templating language. As markup text, the programmable component may be directly edited in the markup format of the contract.

By instantiating programmable components into the body of a document, a hybrid computable and natural language document, such as a contract, may be created, i.e. a compound contract. Programmable components (e.g., clauses and tags) may: (a) interface with external resources to drive events and operations both internally and externally; (b) execute code, operations, and/or transactions on BDLs either natively/directly (e.g., where no prior processing is required), such as BDL-based scripts triggered/invoked directly from a programmable component, which may include passing ‘static’ data such as parameters to ‘on-chain’ scripts) or via code that interfaces with ‘on-chain’/‘on-ledger’ code (e.g., a programmable component that performs an ‘off-chain’ operation such as calculating a price, the output of which is subsequently passed to BDL-based scripts to perform an ‘on-chain’ operation); (c) map to, or otherwise display, natural language; (d) interface with data storage (including a contract object graph such as in the approach described in U.S. patent application Ser. No. 15/640,276, filed on 30 Jun. 2017, which is hereby incorporated in its entirety by this reference), a database, BDL (including a BDL-based “smart contract” system), file system (e.g., IPFS); (e) be executed on a peer-to-peer or other decentralized or distributed network/architecture, or via a client/server infrastructure, either locally, in a data center, a cloud infrastructure, or other appropriate architecture. The foregoing are exemplary. Programmable components may possess additional and/or alternative attributes, functionalities, and incidents.

A programmable clause is preferably a programmable component. In one embodiment, a programmable clause may be substantially similar to the programmable clauses described in U.S. patent application Ser. No. 15/476,791, filed on Mar. 31, 2017, which is hereby incorporated in its entirety. A programmable clause may be generally defined as a component used within a contract that is, at least partially, computable, and operates to define at least a portion of a contract between two or more parties. Programmable clauses are intended to operate as legal clauses within a contract and interface with a variety of resources external to the contract on both an input and output basis to drive events, actions, and operations at least within the logic of each clause, between clauses of a contract, and upon external systems (e.g., blockchains and distributed ledgers (BDL), enterprise systems such as Enterprise Resource Planning (ERP), Human Resource (HR), Customer Relationship Management (CRM), Inventory Management Systems (IMS), Supply Chain Management (SCM) and other systems and applications, web services, Application Programming Interfaces (APIs), Internet of Things (IoT) and network-connected devices, IoT platforms, payment, financing and accounting systems, and many others). Programmable clauses may be connected together. A programmable clause component may be called from another programmable clause component to execute a function/method. A programmable clause may be instantiated as code on a BDL, using/interfacing with BDL scripts, or may be wholly ‘off-chain’ or a hybrid (e.g., where ‘off-chain’ code of a component calls on-chain code, compiles to ‘on-chain’ code, passes parameters/objects to ‘on-chain’ code, etc.). Other alternative or additive approaches may also be used.

A transaction performed on a BDL may include calling functions in on-chain code, passing parameters from off-chain code to on-chain code, via API or any other suitable approach to perform an operation such as the transfer of a digital asset/token (e.g., where represented as an on-chain “smart contract”); storing data on-chain (e.g., an object created by an off-chain programmable component or a reference such as a hash to the same); creating an on-chain asset/“smart contract”; compiling and committing bytecode to a BDL, or any other operation.

A tag is preferably a programmable component that is an object or series of objects. A tag may mirror the logic of a programmable clause, multiple programmable clauses, part of a programmable clause, or may be unrelated. Multiple tag components may be used in any given clause. Where used in a manner unrelated to a programmable clause, a tag component may execute functionalities such as calculating price in an invoice based upon delivery data. FIG. 2 depicts tag components within clauses in an exemplary contract structure and their relationships inter se and with external resources. This example shows a tag component utilizing data from a network-connected device (which may take any suitable form, such as a sensors, machinery, vehicles, trackers, actuators, and other devices). The tag component in clause 1 may draw in delivery information from a geolocation device, UAV, or similar to determine whether delivery is made in accordance with the requirements of the programmable logic. The tag component in clause 2 may then use the state of the first tag component to execute its logic to determine the price based upon the date and/or delivery metrics (e.g., whether shipping conditions such as timeliness, temperature, vibration, humidity, etc. are met). The tag component in clause 5 may then trigger BDL scripts to invoke a transaction on a BDL using the state of the tag component in clause 1 (i.e., delivery has been made) and clause 2 (i.e., the price accounting for any adjustments based upon delivery performance). The tag in clause 5 may also initiate a transaction that transfers custody of a token or other digital asset on a BDL to the purchasing party reflecting the transfer of title to the delivered goods. Clauses 3 and 4 may be natural language clauses that do not feature tag components.

FIG. 5 depicts an exemplary interface for the configuration of a logic-based tag with a contract. The tag is placed within a natural language clause and features logic for the computation of the price payable based upon the state of the contract. In this basic example, a ‘price’ tag is selected from a library of existing programmable components. The exemplary tag computes the price payable based upon a master agreement. The price is dependent upon the delivery date. For every day in which the delivery date is missed, the price decreases by 2%. The price tag references the ‘delivery’ tag. The price is then used as the basis for calculating the cost of purchase orders etc. that are placed under the master agreement. The tag may be added to the document using ‘drag-and-drop’ functionality, or other appropriate mechanism. Logic, inputs and output resources (e.g., APIs, other programmable components) may be configured for the tag (e.g., after it is added to the document). As stated herein, any suitable form of logic may be used. Tags may also be configured without existing templates, such as in an IDE or similar environment. Outputs from the tag may be specified (e.g., output price data to an accounting/invoicing system) or, alternatively, via another interface or mechanism that aggregates or sets certain types of output (e.g. accounting data) to one or more specified resources or prompts the user to forward that information to specified resources. For example, outputs may be: (a) specified in the tag and aggregated before forwarding to external resources; (b) not specified in the tags, but collected/aggregated directly from contracts and then passed to external resources; or (c) a combination (e.g., outputs are specified in the tag and data is aggregated and parsed and/or analyzed by a machine learning mechanism or similar to extract salient information from documents and tags. Resources to which data is output may be specified by in a variety of ways. One approach is to integrate and configure resources through an interface (e.g. API connections).

Programmable components may form objects that accomplish certain general types of actions. Objects may take a variety of forms that will often depend upon the nature of the programmable components within a given document. For example, object functionalities may pertain, but are not limited, to: (a) Executed Events—such as transactions (e.g., payment made via an API call), state updates (e.g., changes to values such as a price change); (b) Current Status—objects that store data pertaining to the current state of components (e.g., a periodic storage of geo-location data pertaining to a delivery such as where this is provided by a sensor to the contract or stored on a supply chain/logistics system or supply chain-based BDL) as opposed to events that have been executed by programmable components. Storage of such objects is preferably defined within the logic of a tag component (e.g., a ‘delivery’ tag component in this example may store or reference an external record either when it becomes available or may store the state at a given interval); and (c) Executable Events—such as the right of a party to a document (e.g., a contract) to perform an operation (e.g., termination, based upon the state of the contract). These permit an operation to be performed under a given programmable component but require external input to do so.

The programmable logic of programmable components may be in any suitable programming paradigm, such as functional languages or imperative languages. In a preferred embodiment, the programmable logic takes the form of an object-orientated paradigm. Other paradigms may be used. A domain specific language may be used to express suitable instructions for contractual events, commercial events, operations, etc. Programmable logic may be Turing complete or incomplete. The programmable logic may include integrations with: (a) other tag components (e.g., the output of another tag component); (b) Application Programming Interface (API) integrations: (c) Internet of Things (IoT) and other network-connected devices; (d) databases; (e) blockchain and other distributed ledgers (BDLs); and (d) other integrations and resources to provide data to, or otherwise interact with the programmable logic. The programmable logic of a programmable component may be executed by method/function calls. A programmable component may be called from another programmable component to execute a function/method. Other approaches may be taken.

Programmable components may include any suitable data depending upon their purpose. An exemplary programmable component may include at least one of the following: the parameter(s) that the component will display; the identifier of the component; the programmable logic that the component will execute (including any integrations etc.); and/or the time and date of creation of the component. Each programmable component may also include metadata, such as transaction data that pertains to a tag on a distributed ledger/blockchain (e.g. “smart contract” references/identifiers, addresses etc.).

Preferably, the compound contract system uses a communication mechanism by which a source document application (or series of source applications) and a destination document application exchange data. The source and the destination pass programming functionality between themselves to enable content from the source application to be used within the destination (or parent) document. The destination document may take any suitable type/format including (but not limited to): portable document format (PDF); structured binary documents, such as word processed documents; plain text, such as ASCII and UTF-8; rich text format (RTF); hypertext markup language (HTML) or HTML-based documents; extensible markup language (XML) or XML-based documents; other markup or markdown document formats and types, or any other appropriate file type/format. The source application(s) may define and exposes the programmable components. Typically, where a contract document is at issue, the source application will take the form of a contract management system (CMS) for computable or data-driven contracts. The CMS mentioned here may be substantially similar to that described in U.S. patent application Ser. No. 15/476,791 and depicted in exemplary fashion in FIG. 14.

Alternatively or in addition, other forms of relationship between the source and destination applications may be used. For example, a source application extension, plugin, or widget embedded within or used by the destination application (e.g., via API) may be used, or another, intermediary application may be used that communicates with both source and destination systems. A Software Development Kit (SDK) around a domain specific language or other language and which may, for example, include APIs exposing a source application, may be made available to express and instantiate child components from a source application in a parent document. Preferably, in whichever means is used, the destination application allows objects to be edited from within the destination application. Other structures and approaches may also be used.

In addition, the communication mechanism may benefit from the formation, storage, execution, and management functionalities described in U.S. patent application Ser. No. 15/640,276. The objects will preferably take the form of computable compound contract programmable components, preferably programmable clauses and tags, preferably supplied by the CMS. The destination will preferably be a digital document that is capable of containing natural language content; such that a compound contract may comprise both natural language and executable programmable components. This thereby enables hybrid contracts and other documents that include executable programmable elements.

The source application may call the destination application when it is necessary to make changes to the component object(s). As an example, a programmable clause may be created and instantiated within a word processed document. That programmable clause may interface with a variety of resources and may be executed in the manner outlined in U.S. patent application Ser. No. 15/476,791 and/or U.S. patent application Ser. No. 15/640,276. The programmable clause is created and interacted with using the source application through any suitable means. Changes may therefore be made to the compound document irrespective of the means used to do so. For example, where appropriate, a third party document application (i.e., not native to the contract management system) may be used with an appropriate extension/API etc. by one party, and the other party/parties may use the contract management system where it offers this functionality natively. Both interact with the source application.

In one variation, the source application may treat these as separate instances, sharing the executable component. In another preferred variation, there is only one instantiation of the executable component by, and in, the source application. Preferably, this instantiation occurs by way of a link between the object in the source and destination application. The link is preferably updated automatically. When the source updates the object, the destination receives a message and updates the object display instantiation and/or other metadata displayed. The object display is preferably an augmented text view of the programmable clause or tag as depicted in exemplary fashion in FIG. 6. FIG. 6 depicts a simple supply of goods master agreement under which a purchase order is made. The purchase order in this example is appended to the contract. This may occur by virtue of a common reference in the pricing clause and the purchase order. This may occur whether or not the referenced components are in a annexed document or not. The purchase order tags are input enabled (as described herein) and, in this example, act as an input to the programmable clause as to the number of units ordered and the date of order. The order itself may be executed on a third party procurement or order system or may be executed as a transaction on a BDL system (which may make use of one or more transaction scripts in an ‘on-chain’/‘on-ledger’ library as depicted in FIGS. 7 and 8). Parameters may be passed to the code to execute (e.g., the units, SKUs, dates etc.). This data may also be stored in a contract object graph (COG); this may then be passed to the ‘on-chain’/‘on-ledger’ code (see U.S. patent application Ser. No. 15/640,276).

A programmable component may be represented as a control that may be dropped within a contract. Each instance of a given programmable component control type will preferably share a common set of data, such that an update to one instance will update the data in all others within the compound contract. Additionally, multiple programmable component controls may be linked together in order to chain data flows between them.

In addition to control types, programmable components may have complex inheritance hierarchies. A child component may be a parent of another child component (e.g., where there is a link between two or more components) and one child may be the child of multiple parents (e.g., where multiple documents reference/use the same component). Child components may be from different source applications and/or aggregated from other source applications through one or more source applications.

In some variations, Uniform Resource Identifiers (URIs) may be used to identify resources, which when accessed, return representations of current child programmable component state which are linked via URI references, and are stored (which may, in one embodiment, use a graph data structure, which in one embodiment may be substantially similar to that in U.S. patent application Ser. No. 15/640,276). FIGS. 9 and 10 depict an exemplary structure. The component relationship object of a URI establishes a link between the parent and the child. For example, a child programmable clause in a parent compound contract may be linked by the component relationship object. A URI is a Universally Unique Identifier (UUID) for a programmable component (i.e., programmable clause or tag). Depending upon the exact nature of the component, the UUID may differ. The URI may, where applicable, be an ‘on-chain’/‘on-ledger’ “smart contract” address or an ‘off-chain’ programmable component address, which may itself be linked to ‘on-chain’/‘on-ledger’ code in substantially the same way as outlined in U.S. patent application Ser. No. 15/476,791. Preferably, a standard UUID format is used. A ‘master-UUID’ and a ‘sub-UUID’ may be used—this may be particularly beneficial to achieve UUID standardization (e.g. a ‘sub-UUID’ of a BDL “smart contract” address and a master-UUID that is linked to the sub-UUID).

As shown by FIG. 10, an exemplary programmable clause (e.g., a ‘pricing’ clause) may be represented by a programmable clause child component in a parent compound contract, and linked and referenced by a URI.

Parent and children components may be instantiated as standard form templates or may be versioned. Versioning preferably follows substantially the same approach as outlined in U.S. patent application Ser. No. 15/640,276 for both natural language and programmable components. Other approaches or mechanisms may be used alternatively or in addition. For example, a parent document and a child component may be versioned independently of one another. A child component, such as a programmable clause, may be versioned either in pre-formation or post-formation. Versioning at the pre-formation stage refers to the establishment or negotiation of the contents of the compound contract prior to the execution of the contract (e.g., the negotiation of programmable and/or natural language clauses). Versioning at the post-formation stage refers to the execution of a contract document by executing the contract and its programmable components. The state of the compound contract document—in both pre-formation and post-formation—may be stored in a ‘Contract Object Graph’ (COG) substantially similar to that outlined in U.S. patent application Ser. No. 15/640,276. The COG functions to store the state and history of a contract document through a graph of objects as the contract is versioned and as events, operations, and actions occur in execution (e.g., a transaction is executed on, or state is pushed to, a BDL; data is pushed to an external system or application (e.g. via API); an update message is received to execute a function call or similar, etc.).

Through the interface layer, a system of preferred embodiment can interact with external sources. Interaction with an external source may comprise and/or relate to data storage on or through an external source (e.g. storage of programmable components, instances of programmable components, general contract data, contract data output, contract libraries, or libraries of programmable components), data configuration on or through an external source (e.g., updating stored data, changing stored data, copying data from/to an external source), execution (e.g., signals to execute the compound contract, execution of contract on an external source), and/or communication with an external source (i.e., systems that respond and interact with the contract). Interaction with an external source may alternatively comprise of different actions dependent on the source and compound contract. The external sources may be any component that can interact with the compound contract. In one preferred example the external sources are multiple BDLs. In this example, a compound contract may be stored on-chain in a BDL, in whole or in part (e.g., BDL-based scripts that are embedded in, used by, linked to, executed by, or interface with, a programmable component in a compound contract). Linked programmable components may be stored on other BDLs, the same BDL or in other ways. The stored on-chain data may additionally be used to perform a transaction. External signals may be received from other BDLs that may cause the execution of a programmable component of a compound contract, changing the state of the compound contract on the BDL that stores the contract.

In addition to data contained within programmable components, programmable components may require and/or have access to external information. For example, programmable components may require data about their state, execution-related data (e.g., stored procedures, custody of an asset, such as on a BDL system), or other such data to be stored that is accessible to be read from or written to. For example, the status of a price tag in a contract may require the history of that price value to be utilized to compute the logic (e.g., where compounded deductions are at issue, or proportional/percentage-based discount limits are used). This data may be updated in real time, or as deemed necessary, e.g. a price tag may be updated real time to reflect market price and history, but could alternatively be updated right before a purchase.

Programmable clauses and tags may connect with multiple resources. A compound contract may have multiple logic components. A programmable clause or tag component may reference other programmable clause or tag components within the same document or across multiple documents. In one preferred variation, a templating system can be used to specify and configure a programmable clause. As is described in more detail below, a template can be specified as a tuple or collection of logic, a model, a grammar and natural language. The model can be optional in some variations, and the grammar may take the form of markup. For example, a purchase order may link to a contract, which links to multiple systems via API, and to a BDL. Data may be obtained via an API to compute logic within the ‘price’ component of a master contract, the output of the logic computation may then be pushed via API to an accounting system to update an invoice and a purchase order document that references the current price from the master contract for a purchase. The data may then be passed to ‘on-chain’ BDL code to execute transactions using the price data when required.

FIG. 11 depicts a basic example of a connection between compound contracts by use of a common reference in a tag component between these documents. The purchase order may reference the ID of the master agreement (e.g., using commands to autofill or reference data). For example, the current price from a tag component in a master agreement may be used in a purchase order for goods under the master agreement. This may then be used to make a payment (e.g., via a payment gateway API) or an asset transfer on a BDL using on-chain/on-ledger code (as described herein) and/or the data pertaining to the order being committed to the BDL (e.g., master agreement ID, price, price object ID, and any other salient data and metadata). Reference may also be made to the data stored in data storage (as stated herein).

Programmable components may be exposed in a variety of ways. In one variation, a programmable component is exposed as a function that accepts data or a request and returns a value. In one implementation, the programmable component may be a RESTful service resource. The programmable components may additionally be configurable. A configuration file such as one specified in JSON could be used.

In one implementation, a JSON configuration object could include target, transform, and config fields. Target is the fully qualified type for the target integration model. Models may be used to provide types for various forms of integration with external sources (e.g., invocations of certain BDL scripts, calls to payment gateways, etc.). Models may optionally not be used as discussed below. The transform field in an exemplary implementation is a valid JSONata (a JSON query and transformation language) transformation that converts the template's response message to the target model. The config field can be a JSON object that contains any additional values that you need for your integration (e.g., API keys, URLs, connection strings, account IDs etc.). A query value may be included in the configuration (e.g., to impose a condition on when the connector is used).

These configurations may be applied in different ways.

Other approaches to configuring, executing instantiating or exposing programmable components may be used in variations or embodiments.

As an example for making an HTTP Post the configuration could be:

```
{
  “target”: “io.clause.outbound.physical.Http”,
  “transform”: “{ \“$class\”:
\“io.clause.outbound.physical.Http\”,\“url\”:
config.url,\“body\”:{\“date\”:response.timestamp, \“note\”:\“Fragile Goods
Update\”,\“amount\”:response.amount}, \“method\”:\“POST\” }”,
  “config”: {
    “url”: “https://requestb.in/xxxxxxxx”
  }
}
```

As an example for MQTT for IoT devices the configuration could be:

```
{
  “target”: “io.clause.outbound.physical.MqttTopicPublish”,
  “transform”: “{ \“$class\”:
\“io.clause.outbound.physical.MqttTopicPublish\”,\“connectionString\”:
config.connectionString,\“topic\”: config.topic, \“message\”:response.amount
}”,
  “config”: {
    “connectionString”: “mqtt://broker.hivemq.com:1883”,
    “topic”: “clause/sample/mqtt”
  }
}
```

As an example for a payment gateway the configuration could be:

```
{
  “target”:
“io.clause.outbound.physical.payments.stripe.PaymentPlatformCreateCharge”,
  “transform”: “{ \“$class\”: \“io.clause.outbound.physical.payments.
PaymentPlatform. PaymentPlatformCreateCharge\”,\“userKey\”:
config.userKey,\“customerId\”: config.customerId,\“amount\”:response.amount *
100, \“currency\”:\“USD\” }”,
  “config”: {
    “userKey”: “sk_test_XXXXXXXXXXXXXXXXXXXXXXXX”,
    “customerId”: “cus_XXXXXXXXXXXXXX”
  }
}
```

And as a final example, for an on-chain BDL transfer between accounts, the configuration could be:

```
{
  “target”:
“io.clause.outbound.physical.payments.crypto.ethereum.EthereumTransfer”,
  “transform”: “{ \“$class\”:
\“io.clause.outbound.physical.payments.crypto.ethereum.EthereumTransfer\”,
\“fromAccount\”: config.fromAccount, \“toAccount\”: config.toAccount,
\“weiValue\”: response.amount, \“privateKey\”: config.privateKey }”,
  “config”: {
    “fromAccount”: “0xd6a33a6xxxxxxxxx”,
    “toAccount”: “0xf8ebf925868f897c1axxxxxxxx”,
    “privateKey”: “0x6afe5c024ae7xxxx”
  }
}
```

As mentioned herein, a further BDL-based configuration of a particular embodiment may call a BDL script to perform an on-chain operation.

In one particular variation related to output from a compound contract, outputs may be added to a task manager engine or exposed to a workflow engine to enable a user to perform actions in relation to the output from a component in the document. For example, a programmable payment clause or tag may, via an API gateway or other appropriate means, queue up a HTTP PUT or other appropriate operation for a transaction through a payment gateway API or the raising of an invoice on an accounting system. A user may be able to manage the execution of such operations using the task manager or workflow engine (e.g., by approving, and thereby executing, queued up operations; declining to approve, and thus not executing, such operations; amending the details of such operations, such as the value or timing of a payment, etc.).

In a preferred embodiment, a templating system is additionally a component of the system. The templating system comprises a mechanism through which to form a programmable component (or entire contract) comprised of both natural language and executable logic. Executable contract logic may be expressed in any general purpose language (e.g., high level language, low level language, machine code, bytecode, or any other suitable approach) and/or markup language as discussed herein. A domain specific language (DSL) for legal contracts is preferably used, but any suitable language may be used.

The templating system can be configured or specified in a variety of ways. In one preferred variation, an instance of a template will include logic, a model, and marked up natural language. In one variation, marked up natural language and logic form a programmable component and used without a model. In another variation, marked up natural language, model, and logic form a programmable component. As a variation of these two variations, the logic may be partially in markup and/or partially in external logic either on a BDL or off-chain script (per programmable clauses).

As shown in the exemplary pseudo code examples of FIGS. 12A-12G, the templating system can define logic, a model, a grammar and natural language around a particular purpose, which in this example is a programmable component with logic (FIGS. 12A-12C), a model (FIG. 12D), and a natural language element (FIG. 12E) that specifies penalties for physical shocks or sudden movements caused to a fragile package in transport for use within a supply agreement. In this example requests and responses such as those specified in FIGS. 12F and 12G may be used.

Templates may be specified in a variety of customized ways to specify rules for different dynamic objectives. The nature of how a template is specified has many implementations. In one variation, a model may not be specified. In one variation, a natural language template may not be used, and, for example, a clause may be expressed wholly in computable logic, comprise a blockchain/distributed ledger-based on-chain smart contract script, or any other suitable means. A domain specific language may have human readable components, grammar, and/or syntax.

A template preferably takes the form of a template contract document including programmable components or template programmable components that replace frequently used and standard fields in documents. Creation or instantiation of a template for a compound contract may preferably occur during creation of the compound contract. The logic of templates may be set/locked (and thus incapable of modification) or may be modifiable. This is particularly beneficial as the creation of templated contracts and other documentation in commerce is commonplace; either through the addition of editable fields within a document, or the use of placeholders, ‘merge’ fields, or similar. The system may therefore provide the benefits of logic-based data-driven documentation within a template format.

A template grammar is marked-up natural language for a template. The template grammar preferably uses a markup language for this purpose. Template grammar markup may express variables, logic expressions, embedded scripts (e.g., BDL scripts, programmable components, or other logic), or any other element. A template grammar generally includes natural language contract text that identifies data-oriented variables such as price, date, and/or other variables or programmatic references. As shown in FIG. 12E, the grammar may specify the presentation of natural language content related to the shipment and the variables of the template. Markup may also be used for formatting purposes.

A template model may be related to the natural language text. The template model can provide a framework for categorizing the variables and the components in the compound component. As shown in FIG. 12D, the model for a clause related to the transit of a shipment may have various variables related to the shipment. Once the elements of a legal contract and the business context are categorized with a data-oriented modeling language, the contract may then be executed using the template's operational logic. This is accomplished by taking the natural language for the clause and inserting bindings to the template model, using a markup language. An exemplary marked-up template for the aforementioned clause may be:

In case of delayed delivery [{“except for Force Majeure cases,”:?
forceMajeure}] the Seller shall pay to the Buyer for every
[{penaltyDuration}] of delay penalty amounting to [{penaltyPercentage}]%
of the total value of the Equipment whose delivery has been delayed. Any
fractional part of a [{fractionalPart}] is to be considered a full
[{fractionalPart}]. The total amount of penalty shall not however, exceed
[{capPercentage}]% of the total value of the Equipment involved in late
delivery. If the delay is more than [{termination}], the Buyer is entitled
to terminate this Contract.

The exemplary marked-up template natural language contains variables. Each variable may start with [{and ends with}], but may also be notated with any other indicator. The exemplary variables in the aforementioned example include:
a) [{“except for Force Majeure cases,”:? forceMajeure}]: this variable definition is a boolean assignment. It states that if the optional text “except for Force Majeure cases,” is present in the clause, then the Boolean forceMajeure property on the template model should be set to true. Otherwise the property will be set to false.
b) [{penaltyDuration}]: this variable definition is a binding. It states that the variable is bound to the penaltyDuration property in the template model. Implicitly it also states that the variable is of type Duration because that is the type of penaltyDuration in the model.
c) [{penaltyPercentage}]: another variable binding, this time to the penaltyPercentage property in the model.
d) [{fractionalPart}]: another variable binding, this time to the fractionalPart property in the model. As this occurs twice in the template grammar, an editor of a preferred embodiment should auto-replace all occurrences.
e) [{capPercentage}]: this is a binding, setting the capPercentage property on the template model.
f) [{termination}]: this is a binding, setting the termination property on the template model.

In one embodiment, variables are bound to a template model. The template grammar and the template model are used to generate a parser for the template, allowing syntactically valid instances to be created. Any types within the model may have an associated template grammar file. For example, the “Duration” type may have a template grammar that captures the syntax for how to enter calendar durations in English, French, etc. These dependent grammars are merged into the template grammar for the root type for the template (the type with the @Template decorator). Given the template grammar and the template model above, the template grammar may be edited (parameterized) to create a clause (an instance of the template). Tags can similarly be used in defining a template or used as an possible construct in a markup text.

In a preferred embodiment, data is stored using a graph data structure. Preferably as a contract object graph (COG) and more preferably in the form of a Merkle directed acyclic graph (DAG). The COG and DAG may be substantially similar to the COG and DAG outlined in U.S. patent application Ser. No. 15/640,276. As detailed in U.S. patent application Ser. No. 15/640,276, the COG may either store the state of the contract document and its components or may reference the state of the contract and its components in external storage (e.g., in a database or other suitable backend). The same graph or a separate graph may define the state history of the document. Alternative approaches to storing relationships and state history may be used (e.g., data stores, databases, message feeds, and file systems such as IPFS).

The DAG can store the history of the events in a document (e.g., operations, computations and similar that occur as a result of committing a contract to execution). Preferably, the edges and nodes are referenced and identified by cryptographic hashes. Preferably, the DAG stores nodes in the graph data structure as objects. The hash may be a hash of the contents of the object. The edges between nodes are preferably hashes of the target objects embedded in the source objects. An object may store any suitable data pertaining to the state of each programmable component (either in whole, such as the state of a programmable component, or in part, such as changes to the state of a variable within a programmable component) or the document as a whole—either as one DAG or a series of DAGs that store the state of each component. Objects are, preferably, immutable, persistent, and/or atomic. Path naming may be implemented by using the Merkle DAG structure. Objects may store data and metadata about any event, including (but not limited to): transactions (e.g., an asset transfer on a BDL), state changes relating to tags (e.g., a price change), amendments to a programmable component, etc. For example, the delayed delivery of a good (based upon delivery data from a logistics API exposed to, and as assessed by, a ‘delivery’ component) is stored as an event in either the delivery component graph or a document object graph data structure. The object may then be used to manipulate, or otherwise be used by, the logic of a ‘termination’ tag to permit execution of the logic of that component to enable a given contracting party to terminate on different terms (e.g., without penalty). In one variation, this may be delegated to another system (e.g., a business rules management system or cognitive system) that may execute the permissioned/conditional operation(s) based upon various rules. In one preferred implementation, compound contracts are maintained and stored on a distributed ledger, more preferably on a blockchain distributed ledger (BDL) and data are preferably stored in the DAG format.

Data, as to the state of programmable components, may be stored and maintained in any suitable medium. Preferably, the data storage is represented in an append-only, immutable, data structure e.g. using the Merkel DAG format and stored in a database or BDL. In one embodiment, both may be used. For example, object data may be represented in the Merkel DAG data structure with object data stored in a database backend, which may be shared or otherwise represented in a BDL. Data may only be written to by the programmable component as permissioned by the component's logic to avoid tampering. In one embodiment, each programmable component may have control over a database that exists solely to store and maintain the state of that component. Alternatively, data may be stored elsewhere and the DAG may either reference data stored elsewhere (such as a database repository, local storage, cloud storage, IPFS) or may itself store the data (e.g. as in the case of a graph database). Alternatively, any other suitable data storage mechanism or multiplicity of mechanisms may be used. Data stores may be interconnected. For example, data objects stored in non-BDL mechanisms (such as a database, the DAG, or other data store) may be passed to, or otherwise used on a BDL (e.g., persisted upon or used in on-chain/on-ledger code, such as an on-chain “smart contract(s)”). Multiple instances and protocols may be used in any given implementation.

Where applicable, DAGs may also be interconnected, such as where two or more documents are used in a given implementation of the system. The data from one DAG may be used by a programmable component within another document (e.g., a purchase order tag or an invoice tag may use the stored ‘price’ data from a master agreement). The logic of one programmable component may query the stored data of the other. Queries are preferably performed as references within the logic of the programmable component.

Another example may be where components interrelate to one another. For example, a ‘delivery’ programmable component may update the aforementioned ‘price’ clause/tag, either directly (e.g., from one programmable component to another) or indirectly through an intermediary entity (e.g., such as an ‘on-chain’ smart contract, application, system, data store, or other entity). For example, a component may update an external resource, whereby the external resource may itself interrelate with another component. Data about the execution process may be stored in an external data store. For example, data about all of the events that occur under each tag, and therefore the document, may be stored in a database, a BDL, or other appropriate data store. Events may include, but are not limited to: component creation, component execution, component state changes (e.g., the change of the price value, etc.), output (e.g., output via an API to the contract management system, external API) etc. Events are preferably time stamped.

The system may additionally include a user interface/configuration panel. Preferably an interface that utilizes a configuration panel (see FIG. 5) is used to enable a user to add, remove, and configure the programmable logic, permissioning, validation settings, and other configurable elements of tag components in one or more documents. The configuration panel may preferably be incorporated into a CMS, but may alternatively be a standalone interface. The configuration panel may be a software implementation, e.g. a user interface on a website that allows a user to configure the compound contract and its components. The configuration panel may alternatively be a physical object. For example, the configuration panel may be a hardwired electronic device that must be plugged in to a network, or connected to the contract by some other means, and can then configure the contract. The electronic device configuration panel may add an additional level of security by being a unique device that can configure the contract. As implied by the previous example, the configuration panel may be unique device that can configure a contract, or alternatively other methods may also be available. The configuration panel may additionally have any alternate form that can facilitate configuring a document with programmable components.

In one implementation, an interface may be provided that enables a user to automatically specify the variables/parameters and logic within a compound contract or document dependent upon the component ‘types’ (e.g., price, delivery, termination, payment etc.). This enables a data-driven document to be created in a similar manner to a traditional, natural language, template. For example, an interface may enable a user to specify the price, price adjustments and conditions, delivery conditions, and other variables within a supply contract. Similarly, a rules-based system or engine may be used either additionally or alternatively to determine the variables and/or logic of components used within a document. The rules-based system may itself accept data inputs such as from an analytics system (including both descriptive and predictive analytics systems), enterprise ERP, IMS and other systems, complex event processing system, or other appropriate system or application. Multiple such systems may be used and data may be aggregated and acted upon to produce complex outputs. A significant potential benefit of this approach is that logic may be optimized to fit the contextual state of an enterprise. For example, data may be run through a rules engine to suggest values for parameters in a document (e.g., the number of a given SKU to order based upon projected demand, or price based upon optimal revenue management calculations).

A document editor of a preferred embodiment may additionally be a component of the system. The document editor is configured to give editing functionality to a user. Compound contracts may be edited, including programmable components added and configured, using a document editor. The document editor may be used on its own, or may be used in conjunction with, or form part of, a contract management system, transaction management system, or similar system. Users may use the document editor to: (a) generate and configure natural language components; (b) generate and configure programmable components (e.g., programmable clauses and tags); and (c) embed and link programmable components into one or more parent contract documents. The document editor may be compatible with any suitable document file format including (but not limited to): PDFs, structural binary formats, XML-based, RTF, images, HTML or markup and markdown languages and formats. Preferably, the editor supports a form of markup for expressing the grammar for component templates, where applicable. The editor may provide further functionality. The editor preferably forms part of a broader contract management system.

The contract management system (CMS) is preferably a document management system that includes a document editor. The CMS may additionally be used to access documents, manage the lifecycle of contracts in the pre-formation and post-formation stage, which may include the creation of a compound contract as well as facilitate document analytics and/or similar functions.

Programmable clauses and tags may be used separately or together in a given implementation. Preferably, where used in a contract, both tags and programmable clauses are used in conjunction with the CMS. Preferably, the CMS is substantially similar to that of U.S. patent application Ser. No. 15/476,791. Preferably, the CMS includes a document editor (which may be similar to the one presented in FIG. 5) that enables users to create and insert components into the destination document. The destination document may be accessible from within the CMS (e.g., where an integration—such as by API—enables this) or may be independent from it. A third party software application may be used or the document editor may be native to the CMS. Contracts and other documents may be formed using the formation processes outlined in exemplary fashion in U.S. patent application Ser. No. 15/476,791 and U.S. patent application Ser. No. 15/640,276.

Programmable components may be managed through a some form of a management platform. This platform may be applicable to a given use case. For example, programmable components used in contracts may be managed through a CMS. The CMS may enable contracts to utilize logic-based expressions but retain a commonly used workflow management tool, as well as enable documents that utilize programmable components to be managed and used alongside those that may not utilize programmable components. In the preferred example where compound contracts are maintained and stored on a BDL, an end user may use a CMS to access and manage programmable components.

The creation and management of components in documents may also occur through a word processing editor, or other application or system by way of plugin, application programming interface (API), or similar. For example, an API, or plugin to word processing or PDF creation software applications, may be used to enable a user to utilize logic-based tag components in the documentation supported by those applications. This may occur through the use of a panel interface (see FIG. 5) or similar interface, whereby the creation and configuration functionalities are available to the user of the software to add, configure and manage components. Other forms of interface may be used. Components may be added to a compound contract or other document through an editor interface. The editor interface may take any suitable form, but preferably enables the addition of both natural language text and the addition and configuration of programmable components.

Multiple users may use the same or different user interface for a compound contract. For example, by enabling different source applications to edit a destination doc using the aforementioned means, it is possible to produce a common infrastructure for editing/forming compound computable contracts without reliance upon a given editor. Furthermore, the parties to the same contract may see the same or different representation of the same document and its programmable components. By enabling different interfaces for a given component, such as a programmable clause, a user is able to configure a document to display data that is most suited to them. For instance one user may have a preference for only viewing the current state of the contract, whereas another user may have a preference for viewing the current state of the contract relative to a past state, while another user may prefer to only view analytics of the contract (e.g., percentage change of a price value within a ‘pricing’ contract clause). An aggregate overview may also be viewable for each document. This may take any suitable form, but preferably takes the form of a dashboard. The dashboard may provide data such as the number of state updates in pre-formation and post-formation, systems updated by the compound contract, transaction logs, and other features of interest.

Tags and programmable clause components may be capable of accepting user inputs. For example, in the purchase order example of FIG. 6, a user may place an order pursuant to a contract by entering a value into the ‘units’ tag of the purchase order at Appendix A. The user may place this order using a CMS or using an alternative interface. This ‘unit’ tag may then instantiate a transaction via an API (e.g., via a procurement application) or smart contract script on a BDL (e.g., through a decentralized application). Various means through which this may occur are discussed herein. The record of the transaction may then be accessed in the contract management system and/or displayed in the object in question or across multiple objects.

Component objects in compound contracts may change state (e.g., throughout the contract lifecycle). Preferably, U.S. patent application Ser. No. 15/640,276 is used to version and store state of the compound documents, both in pre-formation and post-formation stages. Other approaches may be taken. Changes during pre-formation, whether utilizing the pre-formation approach outlined in U.S. patent application Ser. No. 15/640,276 or otherwise, are reflected in the destination document. During the execution stage, the state of the programmable clause may be stored as events that occur in respect of the clause. This state history may be accessed from the contract management system and/or via any other application that interacts with the source application. For example, the history of the execution of the programmable clause may be stored and accessed. Execution events may include, for example, calling BDL ‘on-chain’/‘on-ledger’ code (e.g. from an on-chain engine), receiving data from an ‘oracle’/API/BDL, pushing data to an API, changing state (e.g., where a variable—such as price—changes in a programmable clause due to inputs to the clause), storing data on an external resource etc.

Programmable components may be executed in any suitable execution environment. Programmable components may be executed in a centralized server/client environment, through a multi-tenant cloud computing platform, or using peer-to-peer execution environment which may, in one embodiment, be substantially similar to that outlined in U.S. patent application Ser. No. 15/640,276. FIG. 13 depicts an exemplary process of creating and executing a digital document with tag components.

A compound contract may use a BDL in a variety of ways, which may include (but are not limited to): contract data may be pushed to a BDL (e.g., an object on a BDL to reflect a contract event/state, passing data to on-chain code to execute a transaction, etc.); Calling on-chain code (e.g., from an on-chain library). Calling on-chain code may assist in standardizing on-chain transactions, with associated benefits such as security. Calling on-chain code may further make use of contract data. A library may consist of standard transactions or functions to perform any on-chain operation. Operations or transactions may be “legal” or otherwise; Instantiating code on-chain or compiling to the bytecode of a BDL system for execution on-chain; and interacting with on-chain code to perform transactions.

The system may further include a blockchain/distributed ledger (BDL) component to perform transactions. Any suitable blockchain or distributed ledger may be used. More than one BDL network or similar data structure can be used in any given implementation of the system. Transactions may be performed on the BDL. A transaction may include any suitable operation performed at least partially on-chain, but may occur entirely on chain. FIG. 19 depicts an exemplary interaction between a compound contract and a BDL. Additionally a subset of programmable components of the compound contract may perform one, or more, operation at least partially on-chain on the BDL or on multiple BDLs.

The execution environment may take a number of different forms. In one variation, the execution environment may take the form of an execution engine that exists locally, on a server architecture, a distributed cluster, a cloud-hosted architecture, embedded within a node of a peer-to-peer network or other decentralized or distributed network (which in one embodiment may be substantially similar to that outlined in U.S. patent application Ser. No. 15/640,276), embedded in a node of a DLT. An execution environment may additionally be or include a virtual machine or form part of a virtual machine, which may be run on or run in part of a BDL system. In some variations, the computation engine executes the compound contract over a distributed set of distinct blockchains. In one variation a different BDL specialized for each different tasks may be used for execution. Other approaches may be used.

The computation engine may, in one embodiment, form part of a virtual machine (VM), preferably a process-based stack VM (although register-based stack machines, interpreters, or any other suitable architecture or structure may be used). A VM of any embodiment may be centralized, decentralized, or distributed. A decentralized VM is preferably run on an overlay peer-to-peer network consisting of a plurality of nodes in a similar manner to a BDL-based network. Nodes on the network may run the VM to process operations on the contracts. Preferably, operations are encrypted through use of a variety of encryption techniques which may include (but is not limited to): (a) Homomorphic encryption; (b) Zero Knowledge Proofs; and (c) Key-based encryption (e.g. in-band symmetric key encryption)—so that only parties to, a contract document for example, that are privy to keys give access to the document can decrypt and interpret the data pertaining to operations.

Where a distributed approach is taken, programmable components may be executed on a peer-to-peer basis using a peer-to-peer overlay network between nodes on the network. In one embodiment of a node on a peer-to-peer network, contracts may be executed between nodes on the network in a ‘point-to-point’ basis between only the parties to the contract (‘party nodes’) using a state update messaging protocol. Updates may be sent directly between the parties or through the contract management system. An update may be a request made from the contract or an update exposed directly to the logic of a contract. Alternatively, pubsub or ‘flooding’ methods of sending messages between parties may be used.

In an alternative embodiment, contracting parties may not be peers on the network, and the network may consist solely of servers that perform executions, versioning, and other services; and interact with a client-server basis by parties. In a further alternative embodiment, both node types may be used (e.g. both ‘party’ and ‘server’ nodes co-exist on the same network.

Each programmable component may be a contract account or other object on a smart contract-enabled BDL system or similar system. Designation to execute a contract may enable transactions to be executed using a consensus mechanism. Programmable components that are wholly executed in this manner may be used alongside other programmable components that do not delegate execution to a BDL, or do so only partially (e.g., where execution occurs partially through the ‘off-chain’/‘off-ledger’ computation engine and partially through ‘on-chain’/‘on-ledger’ code). In addition, compound contracts that are wholly or partially executed using a consensus mechanism, may execute parts or all components locally (on or off chain) prior to combining and validating the executed contract.

An event processing system or complex event processing system may also be used as an addition or alternative, as outlined in U.S. patent application Ser. No. 15/476,791.

The system may also enable data pertaining to the current and historical state of programmable components as stored in data storage to form a dataset for analytics (see FIG. 13). Primary data such as events and derived data sets, e.g. causation between events, tag history, may be used to provide business analytics and may be used with other systems to provide analytics including predictive analytics, prescriptive analytics, and diagnostic analytics. For example, stored tag component data may be used for a variety of analytical purposes, including (but not limited to): (a) Analysis of changes in documentation state, the history of document/tag changes, and causation (e.g. penalties and their cause); (b) Risk analysis of penalty exposures; (c) Aggregating data pertaining to documentation status (e.g. number of open orders, status, their value, etc.) and using that data for analysis (e.g. assessing whether inventory levels are satisfactory based upon order documentation and IMS data; using that data with other enterprise data real-time future revenue calculations); and (d) Using pattern recognition and other techniques to provide projections as to the future state of documents (e.g. contracts, orders, etc.) based upon their current state and datasets from historical documents (e.g. past orders from a given supplier). This may be combined with other enterprise or external data (e.g. weather data that may be used to predict any potential effect on shipping times and thus inventory levels related to a supply contract). The graph data structure (where used) is preferably traversed and queried using a query language (e.g. Gremlin, SQL, a proprietary query language) to provide the data needed for analytics.

In a preferred embodiment, data may be provided to users through various forms of data visualization including (but not limited to): graphs, charts, images, tables, spreadsheets, and others. The data may be displayed in any suitable manner, but is preferably displayed through a dashboard or series of dashboards. In some examples, the data visualization may be embedded into the CMS, allowing for simple manipulation of contracts while examining contract data. The data visualization may additionally provide suggestions to help improve user choices.

### 3. Method

As shown in FIG. 15 a method for the management of compound contracts of a preferred embodiment can include creating a markup contract S100, configuring the markup contract S200, and executing the markup contract S300. Creating a markup contract S100 can further include instantiating a programmable component into a contract document S110, and configuring the markup contract S200 can further include initializing programmable components S210, changing programmable components, and validating instances of programmable components S230, within the markup contract. The method preferably facilitates managing markup contracts that include programmable components and natural language such as in the compound contracts discussed above. The method is preferably implemented in connection with a system such as the one described above or any suitable compound contract related system.

The method may be applied at any time during the lifecycle of a markup contract, and thus not all steps of the method will be necessarily applied to every markup contract. In other words, management of a markup contract may comprise of a subset of any and/or all components of contract management. An exemplary overview of creating, executing, and managing a compound data-driven document is depicted in FIG. 16. Other approaches may be taken.

Block S100, which includes creating a markup contract, functions to bring into “existence” the markup contract for usage. The markup contract may have previously existed in a library or in some other form prior, but creating the markup contract S100 specifically generates the contract to be potentially used. Although creating the markup contract allows for the contract to be used, no specific usage needs to be declared, and the created contract may intentionally (or unintentionally) not be used. Creating the markup contract S100 may comprise of writing, taking from a library, generating from an algorithm, and/or creating the markup contract by any other alternative means.

Block S110, which includes instantiating programmable components into a compound contract, is preferably a component of creating a markup contract S100. Instantiating programmable components, as used in this contract, can include inserting programmable components using one or more of various approaches. Thus instantiating a programmable component may occur by automatically generating a programmable component, taking a programmable component from a source library, manually typing in, and/or some hybrid of these or other methods. One example of hybrid instantiation of a programmable component would be using a script to search through a natural language contract for key terms, and then using these key terms to manually write tags into the markup contract. As per the example, creating a markup contract S100 may further comprise of using natural language processing (NLP) techniques to recognize terms within a document, converting the desired terms into programmable components, and instantiating these programmable components into a document S110 to create a markup document. Instantiating a programmable component S110 into a contract document may instantiate a component into a NL document (thus converting it to a markup document) or may instantiate into a document that already has one or more programmable components. Alternatively instantiating a programmable component into a contract document S110 may include instantiating into an empty contract document or a previously nonexistent contract document.

Instantiating the programmable component S110 may also be nested. That is, instantiation of a programmable component S110 may include instantiating of some or all variables within the programmable component, i.e. some or all variables and/or functions within the programmable component may be assigned values (by any possible means).

Instantiating programmable components into a markup contract may include inserting the actual code or markup into the markup contract, but may alternatively include instantiating a link to another programmable component. Thus instantiating a programmable component S110 may include instantiating a parent programmable component outside of the markup document that is linked to the markup document. A parent programmable component, outside of the markup document that is linked to the markup document, may set the value and/or rules of the child programmable component within the created markup contract. Variables within programmable components may also be instantiated in the same fashion, i.e. linked to variables instantiated outside of the markup document.

To summarize, although additional ways are possible, instantiating programmable into a contract document S110 may be occur in at least three general ways:
a) By instantiating a programmable clause or tag directly into the body of the parent document. The component may be pre-configured (in whole or in part) or wholly configured through a configuration interface. In a preferred embodiment, the component is instantiated in the document and subsequently configured; whether pre-configured and then modified, if necessary, or configured and then subsequently added to a document. A component may be added to multiple documents at once (e.g. one programmable may be replicated or referenced in more than one document, such as where a programmable component may be used in a contract and referenced in an appendix). Instantiation within the parent document may occur in a number of ways, including (but not limited to): configuring a component (e.g. via a Command Line Interface, GUI, visual programming interface, or the like) and ‘dragging and dropping’ the component into the document, specifying its location by document co-ordinates, or other appropriate mechanism.
b) The approach above, but where pre-existing text in a document is manually selected for ‘tagging’ and the tag thereafter being configured. In such an instance, the tag may display either the selected document text, a configured variable (such as a numerical price value), or a combination of the two (e.g., the pre-existing text coupled with a configured variable). The same may apply to clauses in contracts; where a clause is selected and the clause is thereafter configured. The text may remain as is within the body of the document or may be augmented in the manners described herein.
c) Natural Language Processing (NLP) techniques may be used to recognize terms within a document and offer suggestions for instantiating programmable components into a document. Terms may include (but are not limited to): payments, durations, termination criteria, delivery etc. This may occur in at least two ways: (i) using an existing library of clauses/tags that are suggested to be input into a document; (ii) suggesting from classified terms, previously used tags, common tagged terms, and/or terms similar to commonly or previously tagged terms, or similar. Machine learning algorithms and techniques may also be used to enable the system and method to learn text patterns in the user's documents, and may offer up appropriate suggestions of the foregoing varieties.

FIG. 17 demonstrate an exemplary process of creating a document with tag components. In a preferred method of creating a template document with logic-based tag components, a digital document such as a contract, invoice, purchase order or other document is created. Components are added to the document. Tag components may be initially configured prior to or after addition to a document. Where pre-set or ‘template’ tag components are used (e.g. from a library) then the component may be added directly to the document. Changes to logic, variables, and other settings may occur after addition to or prior to adding to the document. If any changes occur to the template, the user may opt to save the updated state of the tag component or a new version in the library. This enables a user to utilize tag components that are similar to existing components, but may not be exactly as required for a given document, rather than generating and configuring a new component from scratch. Alternatively, a new component may be created, configured, and then added or a blank tag component (e.g., without any logic/functionality) may be added and then subsequently configured. FIG. 17 depicts an exemplary process where a document—such as a contract—needs to be edited and configured by more than one entity (such as the parties to a contract).

In one embodiment, the creation of a markup contract S100 and the creation, modification, content/state of programmable components may be collaborative (e.g. between contracting parties and/or between users within an organization). In another embodiment, the creation and/or modification of tagged components may be permissioned. For example, the components may only be modified by certain users (e.g., a given contracting party or member within an organization). Both may be combined in a given implementation (e.g., where some clauses/tags are permissioned and others are not).

In one preferred implementation, programmable components are stored and reused in creating markup contracts S100. Programmable logic may be pre-set (e.g. from a library of existing components) that may mirror, for example, contractual clauses or other business logic. Pre-set tagged components may be configured and saved by users for re-use in the same or different documents. Pre-set tagged components may be used in their ‘saved’ state or subsequently modified (e.g. by changing variables or may be stored without such variables). Pre-set components may be of any variety of types. Examples may include (but are not limited to): (a) ‘payment’; (b) ‘delivery’; (c) ‘price’; (d) ‘termination’; (e) ‘party’.

Instantiating programmable components, block S110, may further include adding (or removing) components from (or to) a markup document. Adding and removing components may be automated, or manually done. In one preferred embodiment of manual addition, components are added to the document using a drag-and-drop function. Where a ‘drag-and-drop’ function is used, the user may position this in place in the document. The positioning of tag components in the document is preferably relative to content in the document (e.g., positioned within a clause in a contract such as that they display a parameter (such as a ‘price’ value) when the document is viewed). Where the document that is used supports real-time editing, the text or other components in the document (e.g. tables, etc.) will wrap to the tag component such that it fits inline. Alternatively, the positioning of tag components may be absolute and not relative to the other contents of a document. Others mechanisms for instantiating components may also or alternatively be used. For example, markup command shorthands may be assigned to deploy tags within the text of a document, such as ‘backslash’ commands (e.g./price). Commands may also be used to specify the logic and/or settings of the tag inline (e.g./price $100 unless—delivery/date deduct 2%-day—compound) where—delivery/date references a date in a ‘delivery’ tag component and where delivery is delayed based upon the state of that tag, the price is reduced by a given value (e.g. 2%) over a given time period (per day, compounded). Other types of markup command and other syntax, grammar, and structure may also be used. Inline commands may be used either separately from, or in conjunction with, other methods of configuration such as GUI panel (see FIG. 5).

In some variations, creating markup contracts S100 may further comprise of creating programmable components to be instantiated. Creating programmable components may be comprised of writing programmable logic in code/markup, but may alternatively comprise of combining blocks of pre-made logic components. These reusable logic blocks may have come from other programmable components, composed by a user and stored in a repository or library, automatically generated, obtained from some other external source, or by some other alternative means. In some variations, a programmable component can be a composite of a model, logic, and natural language. Models may be an optional component. Logic as described herein could be a represented in a markup language or some alternative programming language such as a high-level programming language.

A logic block may take any suitable form but preferably embodies a discrete piece of logic that can be used with other such pieces of logic to build the logic required for a tag component. For example, a logic block may be a portion of a contractual clause, an ‘if-this-then-that’ statement or similar. These logic blocks may make use of a variety of interfaces and techniques to develop programmable logic for programmable components. For example, visual programming techniques may be used to link blocks together to create the programmable logic for a tag (including operations performed on external resources such as blockchains/distributed ledgers and network-connected devices). This may be substantially similar to the approach outlined in U.S. patent application Ser. No. 15/476,791. Preferably an authentication mechanism and formal verification are used to ensure that the logic is valid, functional, all necessary configuration occurs (including with any external resources), no broken links between tags exist, etc. Alternatively (or in addition), a command line interface may be used to build programmable logic using blocks of logic. Multiple techniques may be used in any given implementation. For example, multiple ‘views’ may be used to enable programmable logic to be viewed and edited according in different interfaces. Alternatively, the logic of a tagged component may be configured by a user using an IDE or other GUI, CLI, or other interface.

Creating a markup contract, S100, may further comprise of creating an instance of a template model using a template parser of the compound contract. A parser may be automatically generated from the annotated template text (i.e. template grammar) and the associated template data model. Creating a template parser is preferably concurrent with creating the main body of the markup contract. The parser generation may be completely automatic and may support customization of types and nested grammars (FIG. 17 (3)). In this fashion, language specification is inherent to the data model and type system. The template parser may be used to dynamically edit and validate source programmable clause text (potentially using code completion, error reporting, etc.). The editor may be embedded on a webpage, or executed as a SaaS service, or run within an Integrated Development Environment (FIG. 17 (4)), or any other suitable environment. The output of the template parser is an instance of a template model (e.g., a JSON abstract syntax tree that may be deployed to a runtime environment, such an execution engine). Alternatively, any suitable approach may be taken and any appropriate technology may be used. The template model preferably captures a machine readable (and hashable) representation of all the executable data extracted from the clause text (FIG. 17 (5)). The template model may be captured using any appropriate modeling language. Preferably, this takes the form of a lightweight schema language that defines namespaces, types and relationships between types. The modeling language preferably includes first-class support for modeling participants (individuals, companies, etc.), assets, transactions, enumerations, concepts, events, and preferably includes the typical features of an Object Oriented modeling language, including inheritance, meta-annotations (decorators), and field specific validators. The Contracts/Clauses/Expressions/Operators (i.e. members of the modeling language), may preferably be in a language neutral, context-free grammar form (e.g., Backus-Naur form (BNF)). In addition, the language may include formal semantics defining transitions from the contract state input to the contract state output. The language may also define serialization of instances (e.g. to JSON), and validation of instances (e.g. making it easy to integrate with a wide variety of JSON capable external systems). Models may declare dependencies on other models. Other approaches, features, characteristics, support, technologies, data models, bindings, formats, etc. may be used.

Block S200, configuring a markup contract is comprised of initializing S210, changing S220, and validating S230 instances of programmable components within markup contract. Configuring markup contracts S200 functions to create functioning and potentially dynamic and/or automated instances of programmable components. Configuring the markup contract may comprise (but is not limited to): configuring programmable component logic and integrations, variables, parameters and values. Logic may be used to express contractual terms and conditions either in programmable components that are external to the markup or logic may be embedded in the markup (e.g., expressions, conditionals, etc.). Other data pertaining to a document or programmable components may be either manually configured or implemented automatically such as:

Component identifiers such as a UUID (Universal Unique Identifier)—this may be a cryptographic content-addressed hash (e.g. SHA-256 hash function) of the content of the programmable component in whole or in part, or another form of identifier. A combination of methods may be used e.g. a mutable title, an immutable title, and/or a hash or other form of identifier;

Parties to the transaction (where applicable)—in an implementation, these may be specified by a programmable component (e.g., a ‘party’ tag component that specifies the details of the parties to the document—such as a contract—and may include email addresses or other mechanisms for the transmission of the completed document);

Operations/actions that users to a document will execute such as approval, fill in data, signature (e.g. using an e-signature service, Public Key Infrastructure signatures, etc.), and workflow instructions and validation (e.g. order of completion, input validation, etc.);

Permissioning—which party/user is authorized to modify data in programmable components—this may be specified on either a party level (e.g. which users are able to modify certain content of the compound document) and/or a content level (e.g. only natural language, not logic, etc.).

Configuring the markup contract S200 may alternatively or additionally occur by multiple people in real time. Configuring over a contract management system (CMS) may preferably enable collaborative, editing (which may be synchronous or asynchronous) so that multiple users may be able to edit documentation; either concurrently or consecutively using strong and/or eventual consistency mechanisms. Editing of a document may be permissioned. For example, users may have different editing permissions to modify the document, including (but not limited to) adding natural language text and/or programmable components, modifying programmable components and/or natural language text, deleting programmable components and/or natural language text. Editing of a document may occur through a text editor or another system or application. For example, editing may occur through a version control system, which may be centralized or distributed in nature (e.g., a ‘git versioning’ based system whereby users push changes that may be accepted or rejected by other users). This may occur over HTTP, a BDL, or other protocol.

In addition, the contract management system may enable document signing (where applicable) and executing. The signing process may take any suitable form. In one embodiment, signing may be make use of an electronic signature service. The service may be external to, and integrated with, the contract management system via API. In another embodiment, the e-signature service may be native to such a contract management system. In a further embodiment, signing may take the form of a cryptographic signature (e.g., SHA-256, PKI, PGP, etc.). In a preferred implementation of this embodiment, the user signing a uses a public-private key pair. Preferably, a contract management system (where used) may include or be integrated with a private key service. In a further implementation, a Decentralized Identifier (DID) service may be used.

The contract management system may also enable stored documents to be accessed, viewed, and shared with other users of the management system or those that are not users (e.g. via. a shareable URL, workspace, or other suitable method).

The data from of all of the programmable components from within a document may be aggregated via a cloud platform or similar entity and passed to analytics systems or data processing systems for aggregation and analysis, furthermore programmable components may be aggregated and forwarded to other external resources. Aggregating and forwarding programmable component data may enable data points to be created that are not feasible solely from the operation of the programmable components. For example, where data from multiple tag components may be required or relevant to an external system. Additionally or alternatively, data pertaining to inter-tag/component interactions (e.g. as aforementioned in the deliver and price example) may be used for this purpose.

Block S200, configuring a markup contract may further include configuring external sources. As the markup contract, in whole or in part, may be stored in multiple places (e.g., in the cloud, BDL, etc.), configuring a document locally may require updating all copies of the same version of the contract. In addition, beyond updating copies of the markup contract, contract components may interact with external sources as per their logic. External configuration may occur during execution of the contract, but may additionally or alternatively occur during pre-formation or post-formation of the contract. For example, execution of a contract to purchase a commodity at a set price may additionally set the price of the commodity in the market that the purchase is to be made.

Configuring the markup contract S200 may further include configuring of any code on a BDL or similar system. This preferably takes the form of a library of pre-configured and re-usable code that may be referenced in or otherwise used by the programmable logic of components (see FIGS. 7 and 19). This library of code components is preferably standardized to perform certain actions on a given BDL system (e.g. conditioned transactions of various types, escrow, payments, sharing data, etc.). BDL-based operations may take any suitable form. For example, operations may be transactional in as much as they perform, in whole or in part, some function of the contract (e.g., transferring an asset between parties ‘on-chain’) or may perform operations that do not directly pertain to the logic of the terms and conditions of the document (e.g., storing a record of an operation in a contract ‘on-chain’, providing multi-signature functionality for signing the contract or other such operation, etc.). In one particular implementation, the compound document passes parameters in the markup/components that are passed to on-chain code (e.g., a “smart contract” on a BDL), preferably via a resource interface such as an API, to perform an ‘on-chain’ operation. These parameters may be arguments used in executing function calls within BDL scripts. For example, the document may expose payment parameters (e.g., wallet addresses, quantities, etc.) from the programmable components in a document to one or more BDL scripts to execute an ‘on-chain’ transfer when configured events occur within the document (e.g., when delivery of a good is received, a transfer is executed by a programmable component). Details of the BDL script are preferably embedded into, linked with or otherwise referenced in the programmable component (e.g., see FIG. 18). More than one protocol or instantiation of a BDL system may be used per component. Alternatively and additionally, a user of the system and method may configure the markup contract through a CLI or GUI in the same manner as the programmable logic of a tag component. This library of components may be ‘logic blocks’ for the configuration of components using visual programming techniques, as aforementioned.

Initializing a programmable component S210 is preferably a component of configuring a markup contract S200. Initializing a programmable component S210 may include instantiating values to one, some, and/or all variables within the programmable component. Initializing may occur concurrent to creating a markup document S100 and/or instantiating a programmable component S110 to an already existing markup document, but initializing of a programmable component S210 may alternatively occur at some other time. For example, a tag created for the stock price of a company may be initialized at the point of creation with some insider value or the stock price tag may be initialized at some other time, such as when the company goes public and the stock valuated. In some variations, new programmable components may be added (or removed) at later times, potentially leading to initializing of new programmable components S210. Initializing programmable components S210 of a markup contract may occur concurrent to creating a template model for the markup contract.

Block S220, changing an instance of a programmable component, is preferably a component of configuring a markup contract S200. Changing an instance of the programmable component S220 may change the value of one, some, and/or all instances of variables and function values within the programmable component. Changing an instance of the programmable component S220 may be updating variable information as an external source fluctuates (e.g. updating a commodity price variable as the market price of the commodity changes). Changing may occur as the terms of the markup contract change. For example, the function to calculate interest payments may change if a borrower is late on a payment. Changing an instance of the programmable component S220 may occur when certain conditions of the markup contract are met (e.g. once escrow successfully closes, the markup contract may change to allow making transfer payments). Any alternative or combination of alternatives may lead to changing an instance of the programmable component S220 within a markup contract.

Changing an instance of the programmable component S220 may occur automatically by terms and rules of programmable components within or outside of the markup contract. For example, linked values within the markup contract automatically update as the parent document is updated (which may also have updated automatically or manually). Alternatively, changing an instance of the programmable component S220 may be implemented manually, e.g. by a person using a document editor through a contract management system (CMS).

Manually changing an instance of the programmable component S220 may allow for corrections to mistakes, updates renegotiation of contracts or allow for any other foreseeable or unforeseeable situation that may require manual change of a markup contract. In one preferable example, programmable components may be updated through use of state updates. In a preferred example, state updates take the form of messages. Messages may be transmitted through a client/server architecture or decentralized or distributed architecture such as a peer-to-peer network. State updates may operate in a substantially similar manner to that outlined in U.S. patent application Ser. No. 15/476,791 and U.S. patent application Ser. No. 15/640,276.

Changing an instance of the programmable component S220 within a markup contract may be implemented manually using a document editor. Preferably a document editor is used through a CMS. Using a CMS may allow editing multiple contracts, either one by one or simultaneously. In addition using a CMS a user may automate parts of contract configuration while maintaining manual control over a subset of other components.

The method of managing a markup document may further comprise of interfacing with external resources. More specifically programmable interfacing with external resources using programmable components. Documents that are capable of interfacing with the physical world enable new functionalities that were hitherto unattainable. A document may be updated using data the physical world, and dynamically perform actions on external resources. These external resources may include (but are not limited to) network-connected devices such as IoT devices (sensors, actuators), UAVs, machinery, ‘smart city’ infrastructure, automobiles, or other appropriate devices/resources. For example, documents may take the form of insurance policies for automobiles or houses/property that include programmable clauses and/or tags that draw in data concerning the driving trends (e.g. average speed, braking abruptness, route and parking geolocation, total and elapsed drive time, etc.) of a user to calculate insurance premiums (such as where this is dynamically calculated), compliance with insurance policies (e.g. where the vehicle is kept overnight, which ZIP codes it is most present in, etc.). Taking the same subject matter, another example may be an automobile financing document that enforces a lien for non-payment of installments in real-time or near real-time using one or more programmable clauses that utilize “smart contract” code on a BDL to which the automobile is connected (e.g. running a node using a ‘system on a chip’, etc.). When the programmable clause(s) are breached (e.g. payment is not received or registered by the contract/clause), a smart contract script on the BDL—such as from a rules engine or ‘on-chain’ library as outlined in U.S. patent application Ser. No. 15/476,791—may be called/invoked by the programmable clause (see FIGS. 7 and 8 as examples). Alternative approaches may be used (e.g. the code of the programmable clause may deploy code that is invoked, compiled to VM bytecode for execution, or other appropriate means). ‘On-chain’/‘on-ledger’ code may be executed in containers, compiled to virtual stack machine bytecode, called by ‘off-chain’ programmable logic, or other appropriate execution means may be used.

Other interfaces between programmable components and external resources may include (but are not limited to) APIs, application, systems, databases, data feeds, ‘oracle’ services, and similar resources. Such resources may be configured on an input and/or output basis with programmable components. For example, an external payment gateway may be configure to execute a transaction based upon certain conditions specified within the logic of a programmable component in a compound document. Such operations may be performed automatically or may be configured to require authorization by a user of the external resource (e.g., a member of a finance department within a company) and/or the user of a contract management system. Alternative implementations may also be used. In each instance, a dashboard interface or other GUI or CLI may provide a list or other suitable representation of the operations to be performed (e.g., payments pending approval/release).

Block S230, validating an instances of a programmable component S230 functions to confirm the value/state of programmable component and/or a subset of values/states within the programmable component. Validating an instance of a programmable component S230 may be particularly significant if multiple resources are affecting the same markup contract. Validating an instance of the programmable contract may be accomplished using the template grammar and parser for the markup contract.

Block S300, preferably includes executing the markup contract. Executing the markup contract S300 may function as of the contract. Execution preferably involves a dual process of signing the contract, as expressed herein, and subsequently committing the programmable components of the document to a runtime environment. Executing the markup contract S300 may change the state of the of the contract to “executed”, i.e. changing the contract state from pre-formation to post-formation. Additionally and preferably, executing a contract may put into effect all terms and conditions of the contract. Contracts may include NL provisions, but may additionally and/or alternatively include programmable component agreements. Thus executing the markup contract S300 may additionally execute programmable components agreements embedded and/or linked to the markup contract. Executing the markup contract S300 may occur immediately, directly after the “signing” event, but may alternatively occur after some predetermined amount of time has passed, or some agreed upon event has occurred. For example, a contract for selling a set amount of corn to a specific buyer for $3.55 per bushel may become triggered through an external resource and have some update or action executed once the market price for corn has reached $3.55 per bushel. Alternatively, the contract could have been set to be instantaneous and the seller could have sold the corn to the buyer for $3.55 per bushel regardless of the market price of corn. Preferably, executing a markup contract S300 may be an instantaneous event, marking all actions prior to execution as pre-formation of the contract, and everything after the contract post-formation. Alternatively executing a markup contract S300 may take some known or unknown amount of time. The time length of execution may be a decided upon feature of the contract. For example, a reconsideration clause may allow parties a set amount of time to reconsider after contract execution. Alternatively, some physical limit may limit transition from pre-formation to post-formation of executing the markup contract S300 (e.g. data transfer speeds).

Executing the markup contract S300 may occur locally, at the site of the contract, or at some other location. In some variations, the markup contract is locally stored and executing the contract S300 also occurs locally. Executing locally, such as may be used for an off-chain component, may be a preferable method for security reasons. Alternatively, in another example, the markup contract may, in whole or in part, be stored on a BDL. In one implementation, a programmable component may make use of one or more embedded BDL scripts in which the BDL script forms part of the contract logic and, as such, the BDL scripts, store part of the compound contract in whole or in part (e.g., BDL-based scripts that are embedded in, used by, linked to, executed by, or interface with, a programmable component in a compound contract). ‘On-chain’ operations performed using BDL scripts may be executed by a variety of means as mentioned herein, including via API as per other forms of integration. BDL scripts may be used to perform various operations or serve various functions. For example, a BDL script may be used to generate or deal with digital assets, coordinate business processes between parties, or any other appropriate operation.

Executing a markup contract S300 may further comprise of generating a machine readable executable form of the contract. Generating a machine readable form may preferably occur using the templating system.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A system comprised of:
a compound contract, comprising of natural language components and a set of programmable components, wherein the compound contract is written at least in part in a markup language with the programmable components integrated with the natural language components; and
a dynamic layer, wherein the compound contract, through the dynamic layer, is configured to configure programmable components through configuration to:
initialize, change, and validate instances of programmable components within the compound contract,
interface with at least one external resource, and
execute programmable components and execute the compound contract.

2. The system of claim 1, wherein the external resource is a distributed ledger.

3. The system of claim 2, wherein the distributed ledger is a blockchain system.

4. The system of claim 1, wherein the external resources are multiple distinct blockchain distributed ledgers.

5. The system of claim 1, wherein the compound contract is configured to interface with at least one external resource through a blockchain distributed ledger.

6. The system of claim 1, wherein the programmable component utilizes on-chain code of a distributed ledger system.

7. The system of claim 1, wherein the programmable component interfaces with on-chain code of a blockchain system.

8. The system of claim 1, wherein the configuration to interface is further comprised of configuration to store a subset of the compound contract on the external resource.

9. The system of claim 1, wherein the configuration to interface is further comprised of configuration to execute a subset of programmable components of a compound contract on the external resource.

10. The system of claim 1, wherein the configuration to interface is further comprised of configuration to execute the compound contract on the external resource.

11. The system of claim 1, wherein the configuration to interface is further comprised of configuration to transfer a subset of programmable components between the compound contract and the external resource.

12. The system of claim 1, wherein the configuration to interface is comprised of sharing and updating a subset of instances of programmable components between the compound contract and the external resource.

13. The system of claim 1, further comprised of a document editor configured to generate and configure both programmable components and natural language components, and embed and link programmable components.

14. A method comprising of:
creating a markup contract, by instantiating programmable components into a contract document;
configuring the markup contract, by initializing, changing, and validating instances of programmable components within the contract; and
executing the markup contract.

15. The method of claim 14, wherein creating the markup contract includes changing an instance of a programmable component through a document editor of a contract management system.

16. The method of claim 14, wherein at least one of creating the markup contract, configuring the markup contract, and executing the markup contract occurs on a blockchain.

17. The method of claim 14, wherein instantiating programmable components, further comprises of instantiating programmable components directly into a parent document, wherein a parent document instantiation is directly applied to all children programmable components.

18. The method of claim 14, wherein instantiating programmable components, further comprises of instantiating pre-existing text into a document.

19. The method of claim 14, wherein instantiating programmable components, further comprises of using natural language processing in recognizing terms within a document, converting desired terms into programmable components, and instantiating programmable components into a document.

20. The method of claim 14, wherein creating a markup contract further comprises of creating a template model of the compound contract.

21. The method of claim 20, wherein configuring markup contracts is accomplished dynamically using a template parser.

22. The method of claim 20, wherein executing markup contracts further comprises of generating a machine readable executable form of the contract using a template model.

23. The method of claim 14, wherein configuring markup contracts further includes configuring external resources.

24. The method of claim 14, wherein creating a markup contract further includes converting a legal contract into a markup contract.

25. The method of claim 14, wherein creating a markup contract further includes creating programmable components.

26. The method of claim 14, wherein creating a markup contract further includes adding programmable components to a markup contract.

27. The method of claim 14, wherein creating a markup contract further includes removing programmable components from a markup contract.
